(19) United States
(12) Patent Application Publication
(10) Pub. No.: US 2007/0157782 A1
(43) Pub. Date: Jul. 12, 2007

(54) SAW SUCH AS A MITER SAW WITH DIGITAL READOUT AND RELATED MEASUREMENT DEVICES

(76) Inventors: Jason D. Hetcher, Waukesha, WI (US); Matthew J. Mergener, Germantown, WI (US); Dennis J. Cerney, Mukwonago, WI (US); Christopher W. Seward, Sussex, WI (US); Jeffrey M. Brozek, Whitefish Bay, WI (US); Roderick N. Ebben, Dousman, WI (US)

Correspondence Address: MICHAEL, BEST & FREIDRICH LLP, 100 EAST WISCONSIN AVENUE, SUITE 3300, MILWAUKEE, WI, 53202, US

(21) Appl. No.: 11/622,885

(22) Filed: Jan. 12, 2007

Related U.S. Application Data
(60) Provisional application No. 60/758,582, filed on Jan. 12, 2006.
(60) Provisional application No. 60/778,288, filed on Mar. 2, 2006.

(51) Int. Cl. B23D 45/04

(52) U.S. Cl. 83/471.3; 83/490; 83/473

(57) ABSTRACT

A saw. In one embodiment, the saw includes a base, a table, a motor that rotates a blade, a sensor, a controller, and a display element. The table is movable with respect to the base. The blade is movable between a first, substantially vertical position and at least one angular position removed from the first position. The sensor includes an optical encoder disc, and generates and transmits a signal indicative of the angular position of the table with respect to the base or the angular position of the blade with respect to the first, substantially vertical position by monitoring one or more optical reference elements included on the optical encoder disc. The display element receives the conditioned signal from the controller and displays the angular position of the table with respect to the base or the angular position of the blade with respect to the first, substantially vertical position.

### RELATED APPLICATIONS

This application claims the benefit of U.S. Provisional Application No. 60/758,582, filed Jan. 12, 2006, and U.S. Provisional Application No. 60/778,288, filed Mar. 2, 2006, the entire contents of both of which are incorporated herein by reference.

### BACKGROUND

Embodiments of the invention relate generally to power tools and, more particularly, to saws, such as miter saws, chop saws, etc. More specifically, embodiments of the invention relate to digital readouts or digital displays for such tools.

Saws, such as miter saws, chop saws, etc., are commonly used to cut materials for home and/or commercial applications. Some saws include a variety of capabilities that include, for example, allowing a user to adjust a miter angle of a cut, a bevel angle of a cut, a depth of a cut, etc. In order to accurately make such cuts (i.e., miter cuts, bevel cuts, etc.), the user must be able to properly position a variety of components of the saw prior to making the cuts.

### SUMMARY

In one embodiment, a saw includes a base, a table, a motor that rotates a blade, a first sensor, a controller, and a display element. The table is movable with respect to the base, for example, the base is stationary and the table is rotatable between a first position and at least one angular position removed from the first position. The motor is coupled to the base. The blade is movable between a first, substantially vertical position and at least one angular position removed from the first position. The first sensor includes an optical encoder disc. The first sensor generates and transmits a first signal indicative of the angular position of the table with respect to the base or the angular position of the blade with respect to the first, substantially vertical position by monitoring one or more optical reference elements included on the optical encoder disc. The controller receives the first signal from the first sensor, processes the first signal from the first sensor, and generates and transmits a conditioned signal based at least partially on the received signal. The display element receives the conditioned signal from the controller and displays the angular position of the table with respect to the base or the angular position of the blade with respect to the first, substantially vertical position.

In another embodiment, a saw includes a base, a table, a motor that rotates a blade, a first sensor, a controller, and an output element. The table is movable with respect to the base, and the base is stationary. The table is rotatable between a first position and at least one angular position removed from the first position. The motor is coupled to the base. The blade is movable between a first, substantially vertical position and at least one angular position removed from the first position. The first sensor transmits a first signal indicative of the angular position of the table with respect to the base or the angular position of the blade with respect to the first, substantially vertical position. The first sensor can be recalibrated. The controller receives the first signal from the sensor, processes the signal from the first sensor, determines a need to recalibrate the first sensor, and generates a conditioned signal based at least partially on the determination. The output element receives the conditioned signal from the controller and provides an indication to a user of the need to recalibrate the first sensor.

In another embodiment, a saw includes a base, a table, a motor that rotates a blade, a first sensor, a second sensor, a controller, and a display element. The table is movable with respect to the base. The base is stationary. The table is rotatable between a first position and at least one angular position removed from the first position. The motor is coupled to the base. The blade is movable between a first, substantially vertical position and at least one angular position removed from the first position. The first sensor generates and transmits a first signal indicative of the angular position of the table with respect to the base or the angular position of the blade with respect to the first, substantially vertical position. The first signal is generated by determining an angular distance the table or the blade is moved from one or more known reference points. The second sensor generates and transmits a second signal indicative of the angular position of the table with respect to the base or the angular position of the blade with respect to the first, substantially vertical position. The second signal varies according to the angular position of the table and the blade. The controller receives and processes the first signal and the second signal, and generates and transmits a conditioned signal based at least partially on the first signal and the second signal. The display element receives the conditioned signal from the controller and displays the angular position of the table with respect to the base or the angular position of the blade with respect to the first, substantially vertical position.

Other aspects of the invention will become apparent by consideration of the detailed description and accompanying drawings.

### BRIEF DESCRIPTION OF THE DRAWINGS

In the drawings, wherein like reference numerals indicate like parts:

FIG. 1 is a perspective view of a saw according to an embodiment of the invention.

FIG. 2 is a side view of the saw shown in FIG. 1.

FIG. 3 is a partially exploded perspective view of a table assembly portion of the saw shown in FIG. 1.

FIG. 4 is a front view of the table assembly shown in FIG. 3.

FIG. 5 is a side view of the table assembly shown in FIG. 3.

FIG. 6 is another side view of the table assembly shown in FIG. 3.

FIG. 7 is a perspective view of another saw according to another embodiment of the invention.

FIG. 8 is a side view of the saw shown in FIG. 7.

FIG. 9 is a partially exploded perspective view of a table assembly portion of the saw shown in FIG. 7.

FIG. 10 is a top view of the table assembly shown in FIG. 9.

FIG. 11 illustrates a display according to an embodiment of the invention.

FIG. 12 is a top view of a saw having a bevel transducer and a miter transducer according to an embodiment of the invention.

FIG. 13 is a side view of the saw shown in FIG. 12.

FIG. 14 is a bottom view of the saw shown in FIG. 12.

FIG. 15 is a bottom view of a saw, such as the saw shown in FIG. 1, having a potentiometer according to an embodiment of the invention.

FIG. 16 is another bottom view of the saw shown in FIG. 15.

FIG. 17 is a cross-sectional view of a saw, such as the saw shown in FIG. 1, having a bevel transducer and a miter transducer according to an embodiment of the invention.

FIG. 18 is an enlarged portion of the saw shown in FIG. 17.

FIG. 19 illustrates a potentiometer and gear arrangement that can be adapted to a saw according to an embodiment of the invention.

FIG. 20 is a cross-sectional view of a saw having a detent assembly and a microswitch according to an embodiment of the invention.

FIG. 21 illustrates a table of a saw having a plurality of user adjustable detents according to an embodiment of the invention.

FIG. 22 illustrates an arrangement for a user adjustable detent, such as the user adjustable detents shown in FIG. 21, according to an embodiment of the invention.

FIG. 23 illustrates another arrangement for a user adjustable detent, such as the user adjustable detents shown in FIG. 21, according to an embodiment of the invention.

FIG. 24 illustrates a table of a saw having a potentiometer and an optical sensor according to an embodiment of the invention.

FIG. 25 illustrates an arrangement of a microswitch that can be adapted to a saw according to an embodiment of the invention.

FIG. 26 illustrates an arrangement of a proximity switch that can be adapted to a saw according to an embodiment of the invention.

FIG. 27 illustrates a table and a base of a saw that includes position sensing components according to an embodiment of the invention.

FIG. 28 is a bottom view of the table and base shown in FIG. 27.

FIG. 29 illustrates a tape and a slider according to an embodiment of the invention.

FIG. 30 is a front view of the tape and the slider shown in FIG. 29.

FIG. 31 illustrates another tape and slider according to an embodiment of the invention.

FIG. 32 is a cross-sectional front view of the tape and slider shown in FIG. 31.

FIG. 33 is a top view of a position sensing device having a disk and a slider element according to an embodiment of the invention.

FIG. 34 is a side view of the position sensing device shown in FIG. 33.

FIG. 35 illustrates a position sensing device having an encoder and an electronics module according to an embodiment of the invention.

FIG. 36 is a top view of an optical encoder disc according to an embodiment of the invention.

FIG. 37 illustrates a process by which a signal from a transducer can be processed according to an embodiment of the invention.

FIG. 38 illustrates a process by which a signal from a sensor can be processed according to an embodiment of the invention.

FIG. 39 illustrates interconnections between electronic components of a saw according to an embodiment of the invention.

FIG. 40 illustrates another embodiment of interconnections between electronic components of a saw.

FIG. 41 illustrates yet another embodiment of interconnections between electronic components of a saw.

FIG. 42 illustrates still another embodiment of interconnections between electronic components of a saw.

FIG. 43 is a circuit schematic for a circuit that can be implemented in a saw according to an embodiment of the invention.

FIG. 44 is a circuit schematic for another circuit that can be implemented in a saw according to an embodiment of the invention.

FIG. 45 illustrates a wiring arrangement according to an embodiment of the invention.

FIG. 46 illustrates a wiring arrangement applied to the saw shown in FIG. 7 according to an embodiment of the invention.

FIG. 47 illustrates another wiring arrangement applied to the saw shown in FIG. 7 according to an embodiment of the invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

Constructions of a power tool or saw, such as a chop saw, a miter saw, a sliding saw, a compound miter saw, etc., embodying one or more independent aspects of the invention are illustrated in the figures. In some independent aspects and in some constructions, a tool provides a user with feedback that indicates the relative accuracy (and/or precision) of information displayable by a digital readout of the tool. The form of the feedback may vary widely, including, for example, visual information, audible information, and/or a change in operational status of the tool. Independent aspects described herein may be applied, for example, to: (a) miter saws or radial arm saws for making bevel and miter cuts; (b) table saws for making beveled cuts and for setting (i) the width of cuts (e.g., by being applied to the table saw fence) and (ii) the depth of cuts (e.g., by being applied to the table saw blade depth mechanism); and (c) any tool in which an adjustment is made to change the relative position of a tool to a work piece, including, but not limited to, tools such as a hand-held circular saw, a table-mounted circular saw, a thickness planer, a hand planer, a hand-held router with a base, a router mounted to a table, a band saw mounted to a table, a chop saw, a cut-off saw, a drill press, an electromagnetic drill press, a jig saw, or a coring rig.

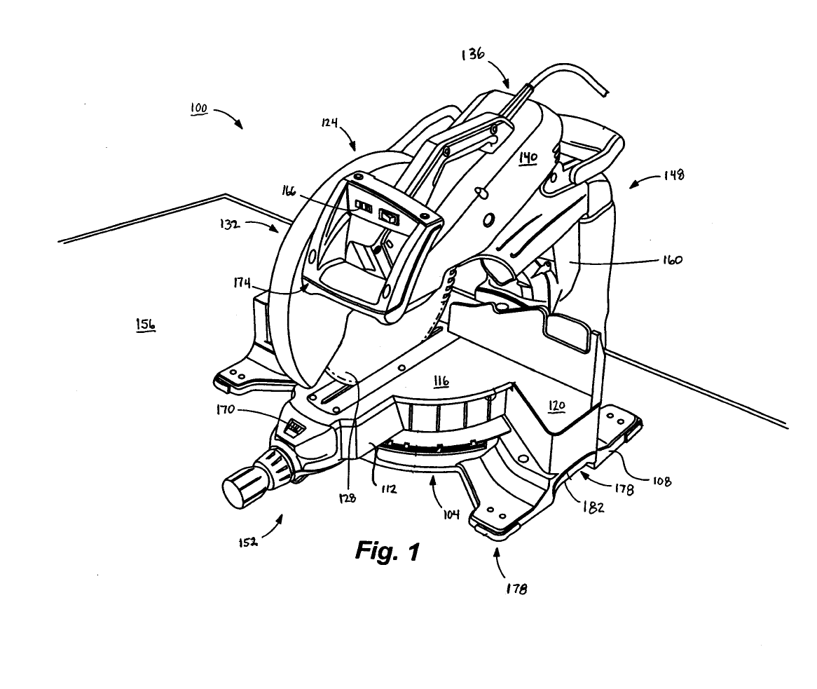

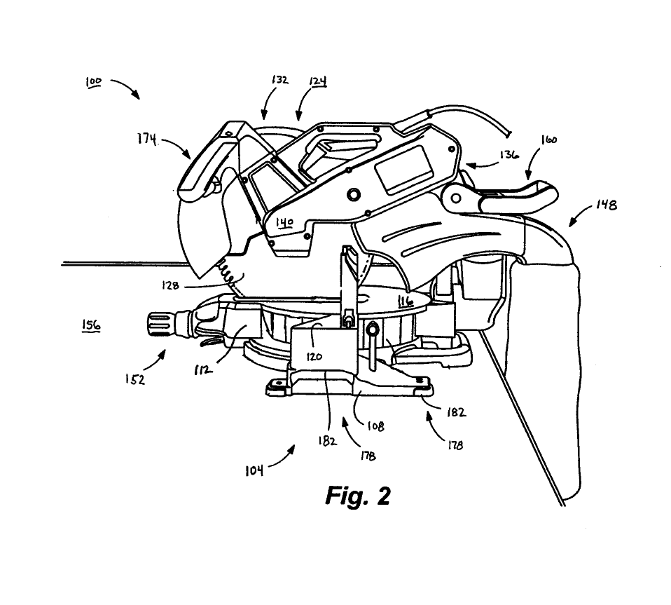

FIGS. 1-2 illustrate constructions of a saw 100, such as a miter saw. In other embodiments, as described in greater detail below, the features of the saw 100 can also be implemented in a variety of other saws including, for example, a chop saw, a sliding saw, a compound miter saw, a sliding compound miter saw, etc.

Generally, as discussed below in more detail, the saw 100 may include a base and table assembly 104 including a base 108 and a table 112 for supporting a work piece. In the embodiment shown in FIGS. 1-2, the table 112 includes a table surface 116, and the base 108 includes support surfaces 120 which are generally planar with the surface 116. The surfaces 116 and 120 cooperate to support a work piece, such as a piece of wood, metal, or other material to be cut.

In some independent aspects and in some constructions, the saw 100 may include a drive assembly 124 operable to drive a saw blade 128 to cut a work piece supported on the base and table assembly 104. The drive assembly 124 may include a saw unit (including the saw blade 128), a motor 136 and a drive train 140 operable to drive the saw blade 128. As shown in FIGS. 1-2, the drive assembly 124 and saw blade 128 are coupled to the table 112 for pivoting movement with the table 112 relative to the base 108 to allow the saw blade 128 to perform various angled miter cuts on a work piece supported on the table 112 and/or on the base 108. In some embodiments, one or more mechanical detents are machined into the base 108, as described in greater detail below, to aid in positioning the table 112 at a variety of angular positions (e.g., 0.0 degrees, 22.5 degrees, 45.0 degrees, etc.) with respect to the base 108. In the embodiment shown in FIGS. 1-2, the saw unit 132 and the saw blade 128 are coupled to the table 112 for movement relative to the table 112 between a raised, non-cutting position and a lowered, cutting position. In some constructions, the saw unit 132 and the saw blade 128 may also be coupled to the table 112 for pivoting movement about a bevel axis to allow the saw blade 128 to perform bevel cuts on a work piece supported on the table 112 and/or the base 108. In some constructions of the saw 100, the motor 136 may include a permanent magnetic motor, while in other constructions of the saw 100, the motor 136 may include a standard or universal motor, a switched reluctance (SR) motor, etc.

In some independent aspects and in some constructions, the saw 100 may also include a fence assembly 144 supported by and cooperating with the base and table assembly 104 to support the work piece. In some independent aspects and in some constructions, the saw 100 may also include a dust collection assembly 148 for collecting debris, dust, etc. generated by the saw blade 128 cutting the work piece.

In some independent aspects and in some constructions, the saw 100 may include a miter angle adjustment assembly 152 providing for adjustment of the angle of the saw blade 128 relative to the work piece about a generally vertical axis (e.g., a generally vertical axis that extends, for example, upward from a work surface 156 toward the drive assembly 124). In some independent aspects and in some constructions, the saw 100 may include a bevel angle adjustment assembly 160 providing for adjustment of the angle of the saw blade 128 relative to the work piece about a generally horizontal axis (e.g., a generally horizontal axis that extends, for example, in the same plane as the work surface 156). In some independent aspects and in some constructions, the saw 100 may include a bevel digital display arrangement or digital readout arrangement 166 and a miter digital display arrangement or digital readout arrangement 170. The digital readout arrangements 166 and 170 can be utilized to display information to a user (e.g., a relative position of a portion of the saw 100, such as the miter angle, the bevel angle, etc., information relating to the operation of the saw, such as motor speed, battery capacity, battery charging status, etc., historical information relating to the saw, such as number of cuts performed, warranty information, etc.), as described in greater detail below.

In some independent aspects and in some constructions, the saw 100 may include a handle assembly 174 engageable by a user to adjust a relative position of at least a portion of the saw 100 (e.g., to move the saw unit 132 and the saw blade 128 between the raised, non-cutting position and the lowered, cutting position, to adjust the miter angle, to adjust the bevel angle, to transport the saw 100, etc.). In some independent aspects and in some constructions, the saw 100 may include an elastomeric material 178 provided on surfaces of the saw 100 (e.g., carrying surfaces, gripping surfaces, support surfaces, protruding surfaces, etc.). The elastomeric material 178 may be formed as a separate grip member 182 which is attachable to the base 108. Alternatively, the elastomeric material 178 may be provided as an overmold.

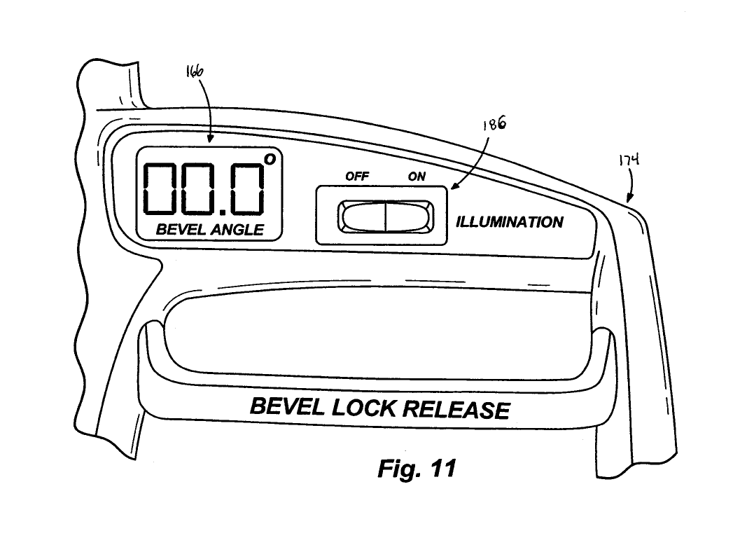

In some independent aspects and in some constructions, the saw 100 may include an illumination assembly 186 (see FIG. 11) for illuminating an object (e.g., the work piece, the surface of the base and table assembly 104, etc.), for indicating a cut-line, etc. In some independent aspects and in some constructions, a transport assembly is provided to assist the user in transporting to the saw 100 to, from and around a job site.

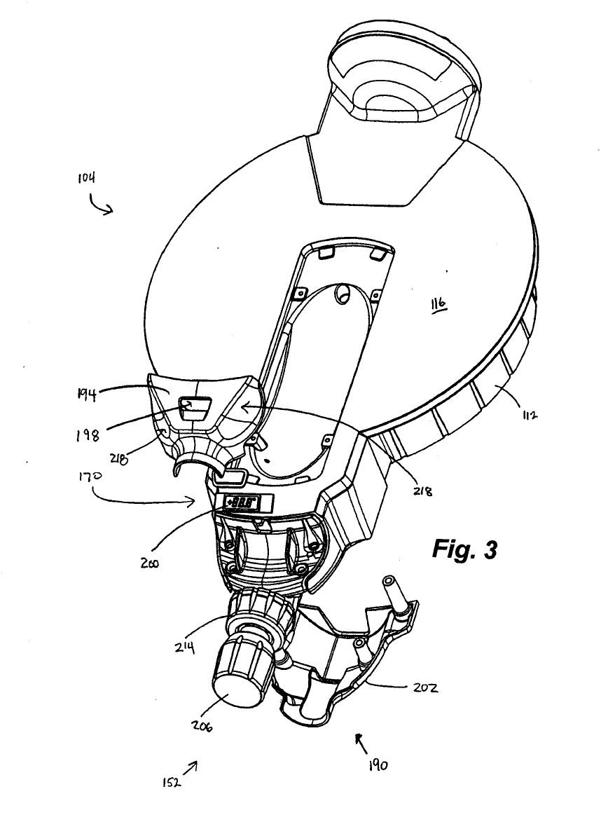

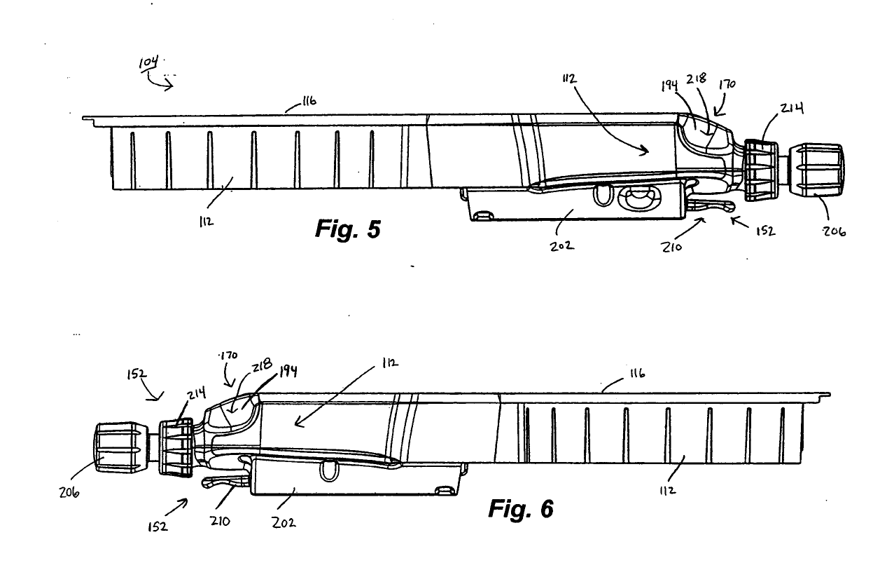

FIGS. 3-6 show the table assembly 104 of the saw 100 more clearly. For example, FIG. 3 is an exploded view of a portion of the table assembly 104. As shown in FIG. 3, the table 112 includes a cover arrangement 190 having an upper cover 194 defining an opening 198 through which a miter display 200 of the miter digital readout arrangement 170 is viable. A lower cover 202 covers the bottom surface of the table 104 to enclose at least some of the components of the miter adjustment assembly 152.

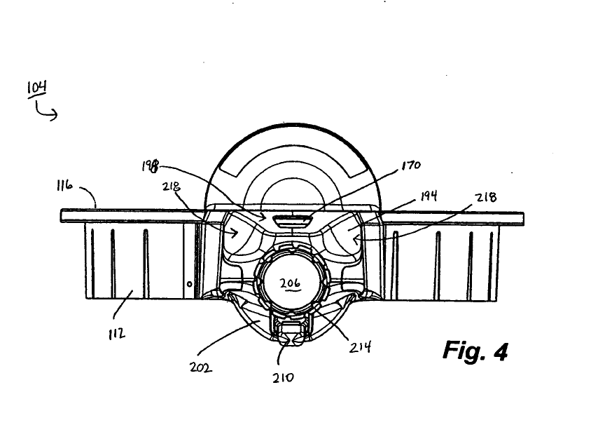

When adjusting the miter angle position, a user can operate controls (e.g., a lock knob 206, a detent lever 210, a fine adjustment knob 214, etc.) to move the table 112. A scallop-shaped recess 218 is defined on each side of the opening 198. A user may place the thumb of the adjusting hand (which grasps the controls and/or table 112) to maintain visibility of the miter display 170 before, during, and after adjustment of the miter angle position. FIGS. 4-6 illustrate front and side views of the portion of the table assembly 104 that is shown in FIG. 3.

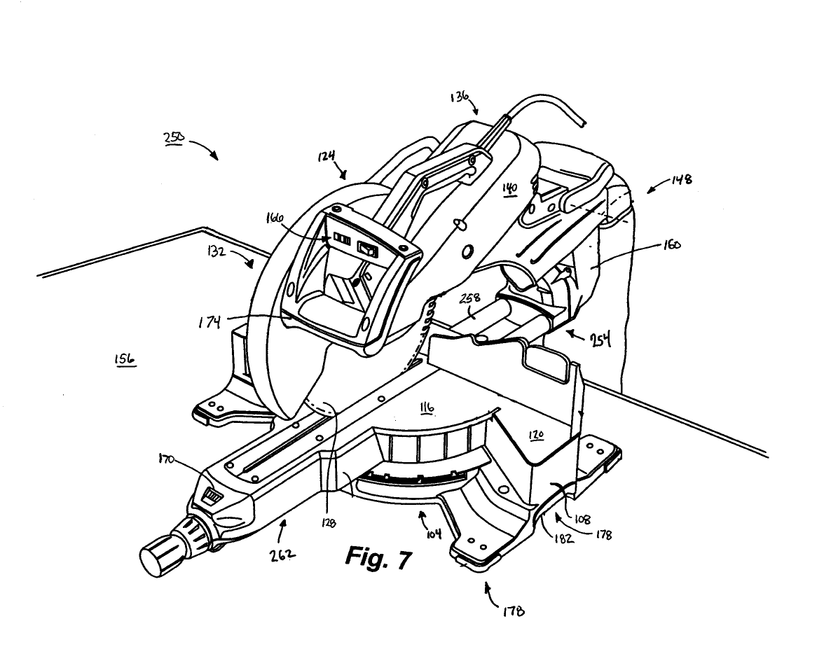

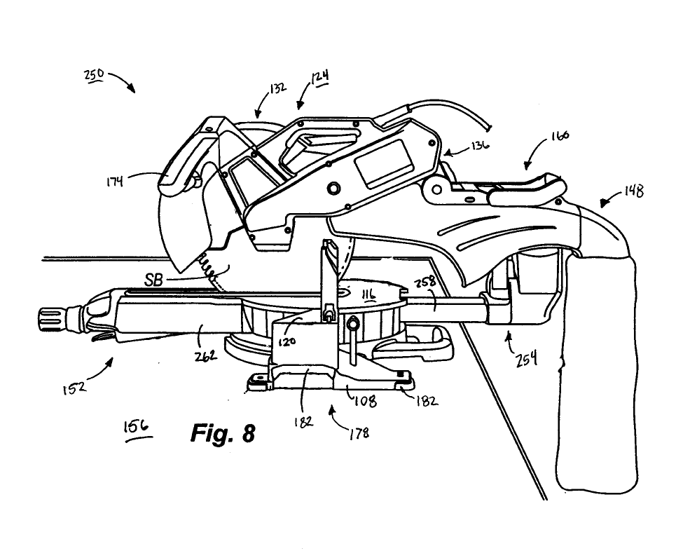

FIGS. 7 and 8 illustrate another embodiment of a saw 250, for example, a sliding saw. In some embodiments, the saw 250 includes components that are the same or similar to components for the saw 100, with like parts labeled with the same numerals. However, the saw unit 132 of the saw 250 is coupled to the table 112 for generally linear sliding movement by a sliding support assembly 254. In the illustrated construction, the sliding support assembly 254 generally includes support or slide tubes 258 supported for sliding movement relative to the table 112 along an axis generally parallel to the bevel axis and for pivoting movement with the table 112 relative to the base 108. The saw unit 132 is supported by the slide tubes 258 for movement with the slide tubes 258 relative to the table 112. As shown in FIGS. 7 and 8, a tongue portion 262 of the table 112 differs from that of the compound miter saw 100 shown in FIGS. 1-6. For example, the tongue portion 262 is generally longer than that of the table 112 shown in FIGS. 1-6 to accommodate the sliding action of the saw unit 132 on the slide tubes 258.

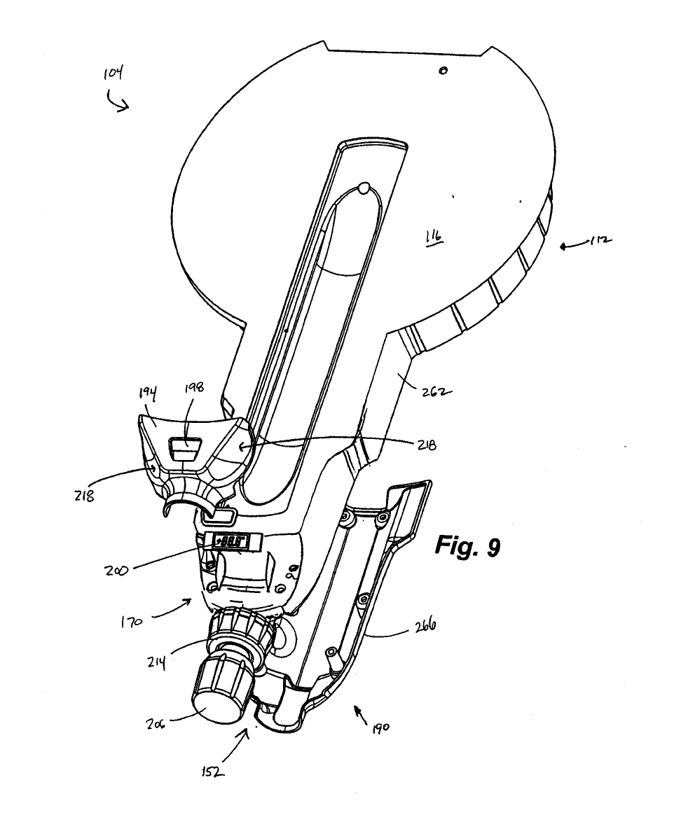

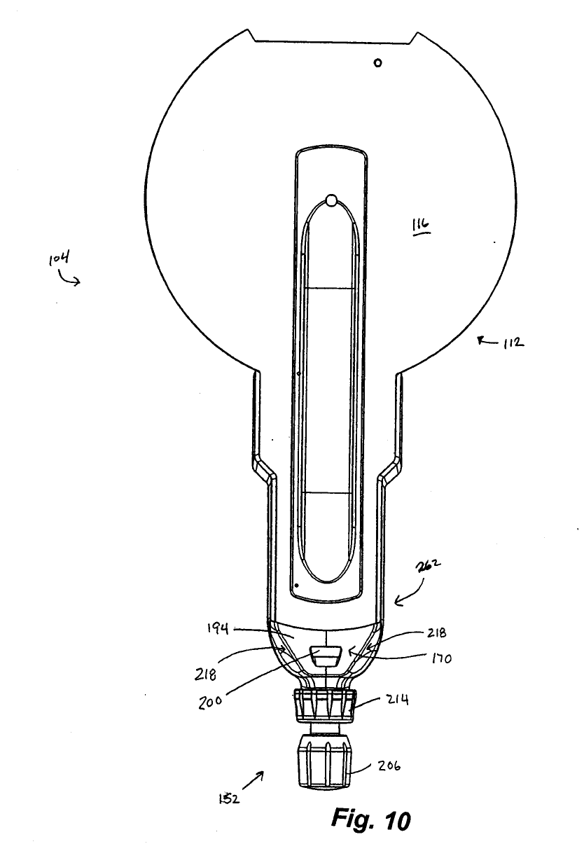

FIGS. 9 and 10 show the table assembly 104 of the saw 250 more clearly. For example, FIG. 9 is an exploded view of a portion of the table assembly 104. As shown in FIG. 9, similar to the saw 100, the table 112 of the saw 250 includes the cover arrangement 190 having the upper cover 194 defining the opening 198 through which the miter display 200 of the miter digital readout arrangement 170 is viable. A lower cover 266 is constructed differently from the lower cover 202 of the saw 100 to accommodate the longer tongue portion 262 of the table 112. FIG. 10 is a top view of the portion of the table assembly 104 that is shown in FIG. 9.

FIG. 11 illustrates an exemplary embodiment of the bevel digital readout arrangement 166 shown in FIGS. 1 and 7. In the embodiment shown, the readout arrangement 166 is included on the handle assembly 174, which also includes the illumination assembly 186. The readout arrangement 166 may be powered by the power source for the saw 100 (e.g., line power, battery power, etc.). Alternatively, the display 166 may be powered by a separate power source. For example, a separate replaceable battery may be provided. A solar type arrangement may be provided (like that on many calculators), and an on-board illumination assembly may provide the power to the solar arrangement. Power may be generated through operation of the saw 100 (e.g., rotation of the saw blade 128, movement of the table 112 or bevel arm, movement of the saw unit 132 (e.g., with a transformer, using low voltage, etc.)).

Generally, the digital readout arrangements 166 and 170 may display information to a user (e.g., a relative position of a portion of the saw 100, such as the miter angle, the bevel angle, etc., information relating to the operation of the saw, such as motor speed, battery capacity, battery charging status, etc., historical information relating to the saw, such as number of cuts performed, warranty information, etc.). For example, in the embodiment, shown in FIG. 11, the readout arrangement 166 can indicate the bevel angle with one or more seven segment display elements. In other embodiments, display elements can be implemented to display other information to the user. For example, other information relating to the saw 100 (e.g., load current, etc.) or information not relating to the saw 100 (e.g., time of day, advertisements, etc.) may also be shown on the digital readout arrangements 166 and 170.

In some embodiments, the digital readout arrangements 166 and 170 may work in conjunction with a variety of electronic components that provide simple calculations using one or two keys or buttons by an operator. Such calculations may be the angle complement finder, a conversion to rise-run a display, a conversion to degrees-minute display, etc. In other constructions, the electronics may provide complex calculations, and a multi-key or button pad may be required. Such calculations may include miter and bevel calculations for crown molding. The results of these calculations may be displayed on the digital readout arrangements 166 and 170.

In the embodiments shown in FIGS. 1-2, the saw 100 includes two digital readout arrangements (e.g., the bevel readout arrangement 166 and the miter readout arrangement 170). Alternatively, the miter angle display and the bevel angle display may be incorporated into a single display. This display may be positioned on the handle assembly 174, or on the tongue of the table 112. Additionally, a single display, with the capability of switching between displaying miter angle and displaying bevel angle, may be used.

In some embodiments, the digital readout arrangements 166 and 170 may be used in conjunction with a transducer system (as described in greater detail below), which may include a zero adjustment and/or a span adjustment. The digital readout arrangements 166 and 170 may be an LCD display and may be operable to display a picture or diagram of the workpiece and/or the worksite. The system may be operable to record and/or display information about the miter saw (e.g., the number of cuts, the run time, the estimated remaining brush life, number of impacts or drops, if any) or other information (e.g., guides to operating the saw, advertising about other products, accessories or services, etc.).

In some embodiments, the digital readout arrangements 166 and 170 can display various operating characteristics of a saw such as, for example, rpm, depth of cut, width of cut, miter angle, bevel angle, etc. The digital readout arrangements 166 and 170 may indicate faults with the saw or required maintenance. In addition, the digital readout arrangements 166 and 170 may provide a low-voltage or low power indication in cases in which the line voltage may compromise intended performance at the miter saw. Additionally or alternatively, the digital readout arrangements 166 and 170 may provide a watt-hour/run-time meter. In order to provide a watt-hour/run-time meter, a device can be provided for monitoring the power consumed and/or the run-time of the miter saw over a period of time. The device can be a separate in-line device, or it can be integrated into the saw. The device can be used as a tool usage tracking device by both the user and a service department.

In some embodiments, the digital readout arrangements 166 and 170 may provide a perpendicularity indicator which would provide an indication (e.g., visual, audible, etc.) to the user when the saw blade is perpendicular to the workpiece (e.g., at zero degrees bevel angle and zero degrees miter angle). The digital readout arrangements 166 and 170 may also provide an indication of leveling of the tool on a work surface. Additionally or alternatively, the digital readout arrangements 166 and 170 may provide an indication of metal in a work piece. For example, a metal detector may be integrated or an accessory, which detects the presence of metal in a work piece, and transmits a signal to the digital readout arrangements 166 and 170 that is indicative of such a presence. Such a feature may provide an indication to the user and/or interrupt operation of the miter saw.

In some embodiments, the digital readout arrangements 166 and 170 may be zeroed at any point on the table with respect to the miter angle and/or bevel angle. The position of the table 112 may be an input to a calculator. Electronics may also be programmable to provide user-desired characteristics (e.g., selected rpm, soft start, breaking time, etc.). The saw 100 may include a separate power source, such as a battery, to power electronics. The electronics may provide control of operation, such as incorporation of feedback, soft-start (to extend the run-time of a battery or to conserve power), auto-reversing, etc. A separate sensor may be provided for sensing characteristics of the work piece or work area, such as, for example, the desired angles, lengths, widths for cutting a work piece. This separate sensor may communicate with the other electronics. Such communication may be wireless, hard-wired with the sensor remaining in a position around the work area, hard-wired with the sensor being connected to the electronics package on the miter saw itself, etc.

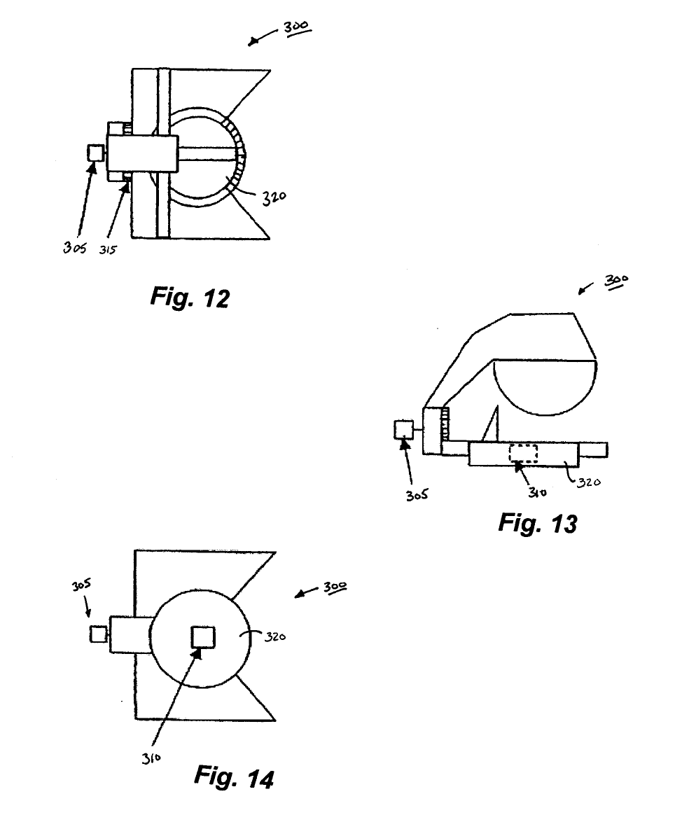

As described above, in some embodiments, the digital readout arrangements 166 and 170 display information relevant to the bevel angle and/or miter angle. In such embodiments, one or more electronic, mechanical, and/or electromechanical sensors and devices can be used to monitor the bevel angle and/or miter angle (in addition to a variety of other information including, for example, information relating to the operation of the saw, such as motor speed, battery capacity, battery charging status, etc., historical information relating to the saw, such as number of cuts performed, warranty information, etc.) and transmit that information to the digital readout arrangements 166 and 170. For example, FIGS. 12-14 illustrate a general arrangement of a saw 300 having a miter transducer 305 and a bevel transducer 310. These transducers 305 and 310 (e.g., capacitive, magnetic, hall effect, optical, reflective, resistive, encoders, etc.) can communicate with a digital display, such as the digital readout arrangements 166 and 170 (see, for example, FIGS. 1 and 7). As shown in FIGS. 12-14, the transducers 305 and 310 may be positioned either coaxial with the respective axes of rotation of the miter angle and the bevel angle or next to or adjacent the moving parts of the saw 300 that impart the miter angle and the bevel angle. For example, FIG. 12 is a top view of the saw 300 that shows the placement of the bevel angle transducer 305 near a bevel angle adjustment 315. FIG. 13 is a side view of the saw 300 that shows the placement of the miter transducer 310 incorporated into a table assembly 320. FIG. 14 is a bottom view of the saw 300, which shows the placement of both the bevel angle transducer 305 and the miter angle transducer 310. In some independent aspects and in some constructions, the saw 300 may also include signal-conditioning electronics operable to convert the signals output by the transducers 305 and 310 into a numerical value corresponding with the miter angle and/or the bevel angle of the saw 300, as described in greater detail below.

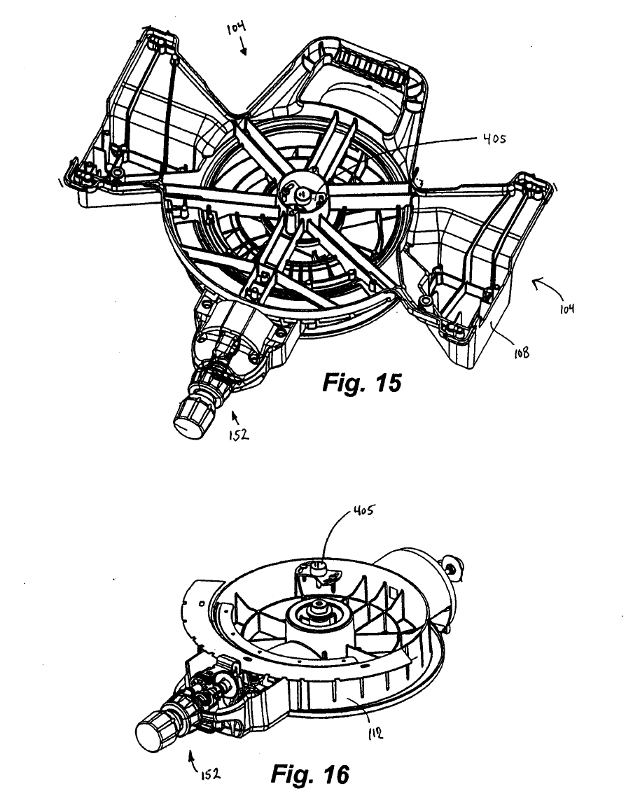

In some embodiments, one or more potentiometers are utilized to monitor the miter angle and/or bevel angle, and transmit the angle information to a display. This may enable an operator to position the miter angle and the bevel angle of a saw unit (such as the saw unit 132) to increased levels of accuracy and precision. For example, FIGS. 15-18 illustrate a miter angle potentiometer 405 and a bevel angle potentiometer 410 (see FIG. 17) that are coupled to the saw 100 shown in FIGS. 1-6. In other embodiments, the potentiometers 405 and 410 can be adapted to a variety of other saws (as previously described). FIG. 15 is a bottom view of the saw 100, which shows the position of the centrally located miter angle potentiometer 405. In the embodiment shown, the miter angle potentiometer 405 is surrounded by the base 108 of the table assembly 104. FIG. 16 illustrates the table assembly 104 with the base 108 removed, which shows the coupling of the miter angle potentiometer 405 to the table 112. FIG. 17 illustrates a cross-sectional view of the table assembly 104, which shows both the miter angle potentiometer 405 and the bevel angle potentiometer 410. As shown in FIG. 17, the bevel angel potentiometer 410 is positioned near the bevel angle assembly 160. FIG. 18 is a blown-up view of a portion of the cross-sectional view of the table assembly 104, which shows the miter angle potentiometer 405 in greater detail. For example, in the embodiment shown, the miter angle potentiometer 405 is coupled to a shaft 415 that is coupled to the table 112. As such, as the table 112 is rotated, the shaft 415 also rotates, providing an input to the miter angle potentiometer 405. In addition to the shaft 415, a washer 420 and bearing 425 are included, which aid in the rotation of the table 112.

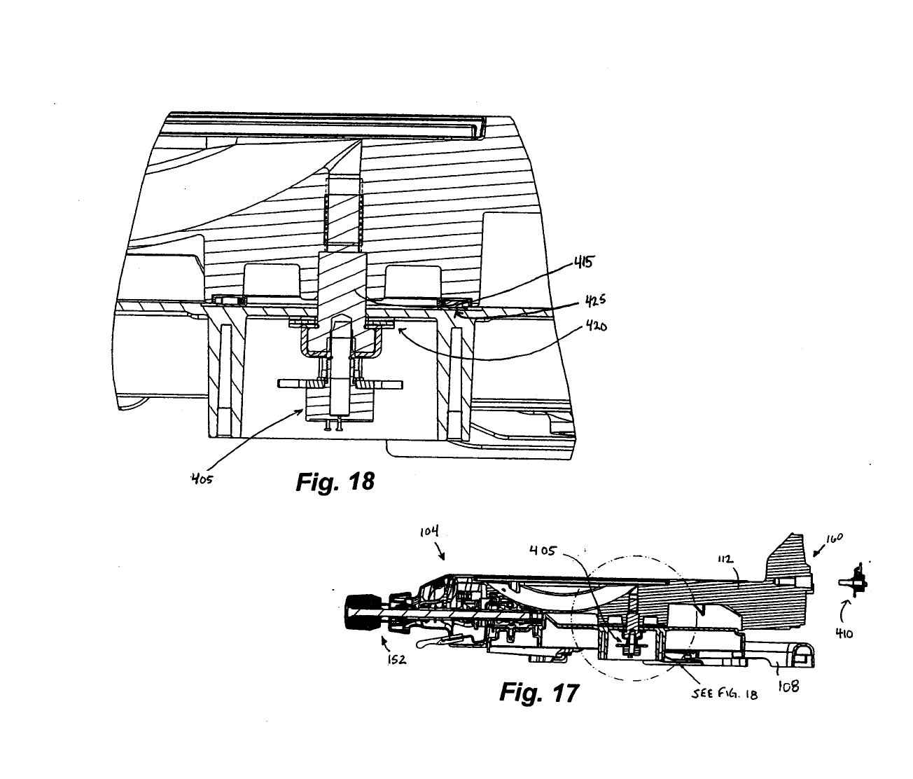

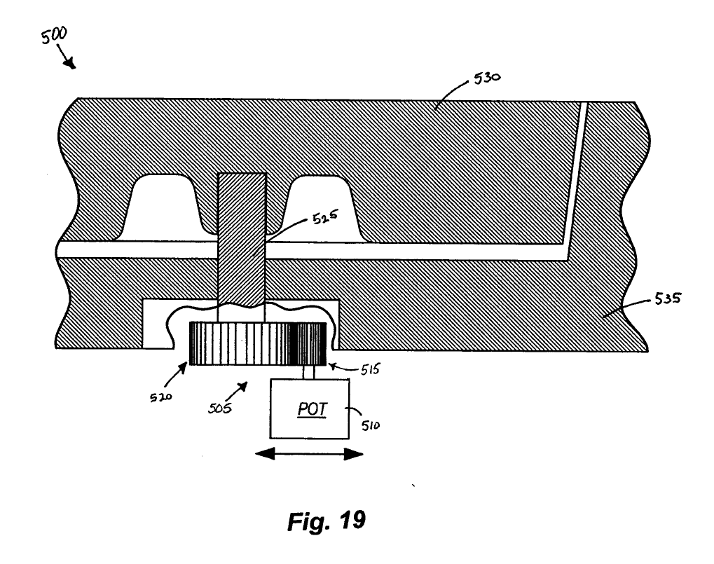

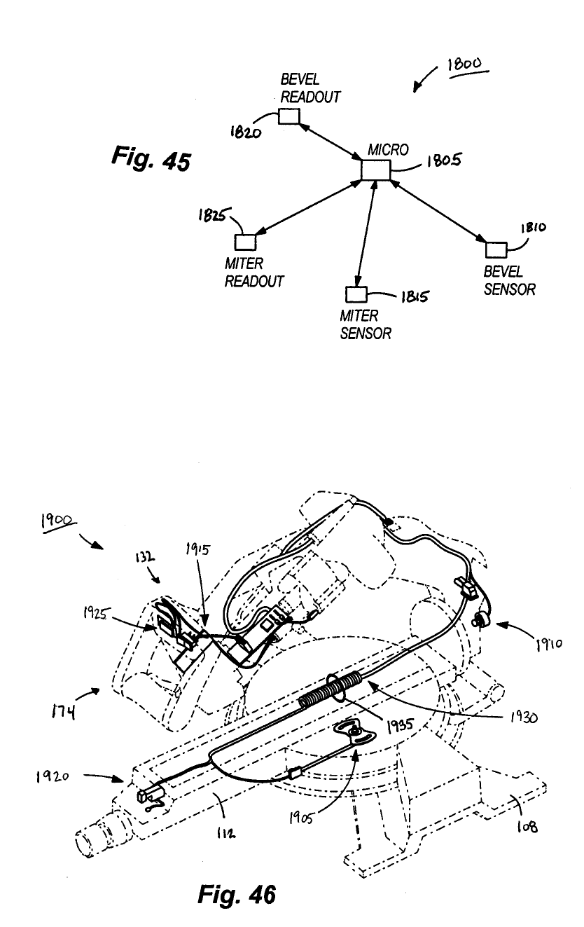

FIG. 19 illustrates a portion of a table assembly 500 (e.g., a table assembly for a saw, such as the saw 100) having a potentiometer and gear arrangement 505. The potentiometer and gear arrangement 505 includes a potentiometer 510 that is coupled to a first gear 515. The first gear 515 is meshed with a second gear 520, which is coupled to a shaft 525 that is coupled to a table 530 of the table assembly 500. A base 535 is positioned between the potentiometer 510 and table 530, and supports the table 530. In some embodiments, the shaft 525 is coupled to the table 530 such that rotating the table 530 causes the shaft 525 to rotate. Additionally, rotation of the shaft 525 causes the second gear 520 to rotate, which causes the first gear 515 to rotate. Rotation of the first gear 515 provides an input to the potentiometer 510. As such, the potentiometer 510 can monitor the rotation and/or position of the table 530 using the potentiometer and gear arrangement 505. In some embodiments, the position of the first gear 515 is adjustable, such that it can be moved between an engaged position (e.g., meshed with the second gear 520) and a disengaged position (e.g., not in contact with the second gear 520). Additionally, in some embodiments, the size or diameter of the first gear 515 is smaller than that of the second gear 520. This gear reduction provides an increased resolution for the potentiometer 510. For example, when the table 530 is rotated, the first, smaller gear 515, which provides an input to the potentiometer 505, turns at a faster rate than the second gear 520 (which is turning at the same rate as the table 530). By increasing the rotations of the gear providing the input to the potentiometer 505 (i.e., the first gear 515), the potentiometer 505 acquires a greater resolution. In some embodiments, the ratio between the first gear 515 and the second gear 520 is approximately 1:3 (e.g., for every rotation of the second gear 520, the first gear 515 rotates three times). In other embodiments, an alternative gear ratio may be used (e.g., 1:2, 1:5, etc.). In some embodiments, a wiring arrangement may connect the potentiometer and gear arrangement 505 to a “remote” display located a distance from the sensor (e.g., see FIGS. 45-47).

In some embodiments, the degree of accuracy of electronic components (such as the potentiometers 405 and 410 or the potentiometer and gear arrangement 505) is such that an angular value displayed on the digital readout arrangements 166 and 170 may not match mechanical detents that are machined into the base 108 (e.g., 0.0 degrees, 22.5 degrees, 45.0 degrees, etc.). Machining the detents to this degree of precision would require that the mechanical detents be held to extremely close tolerances. In some embodiments, one or more microswitches are utilized to monitor the miter angle and/or bevel angle, and transmit the angle information to a display.

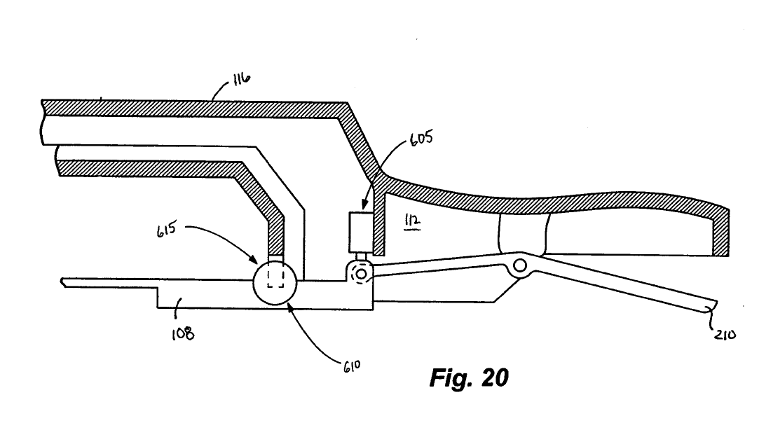

FIG. 20 illustrates structure and electronics to accurately measure and display miter angle settings and bevel angle settings on a miter angle display, such as the miter digital readout arrangement 170 shown in FIG. 1. With reference to FIG. 20, a microswitch 605 (or other position sensing device such as a proximity sensor, Hall-Effect sensor, or optical/laser emitter-receiver) may be mounted in close proximity to a detent override mechanism such that when an operator locks the saw 100 into a mechanical detent 610 (see, for example, circle 615) or passes over a mechanical detent 610, the microswitch 605 may be actuated, thereby resetting or re-calibrating a potentiometer to the desired angle. Alternatively, the position of the microswitch or other sensor may be positioned in a location disposed from the detent override mechanism. This allows, among other things, the system to constantly recalibrate itself to prevent drift, enable more reasonable mechanical tolerances on the detents, ensure that the digital readouts agree with the position of the mechanical detents, and a less accurate or a less expensive potentiometer to be used.

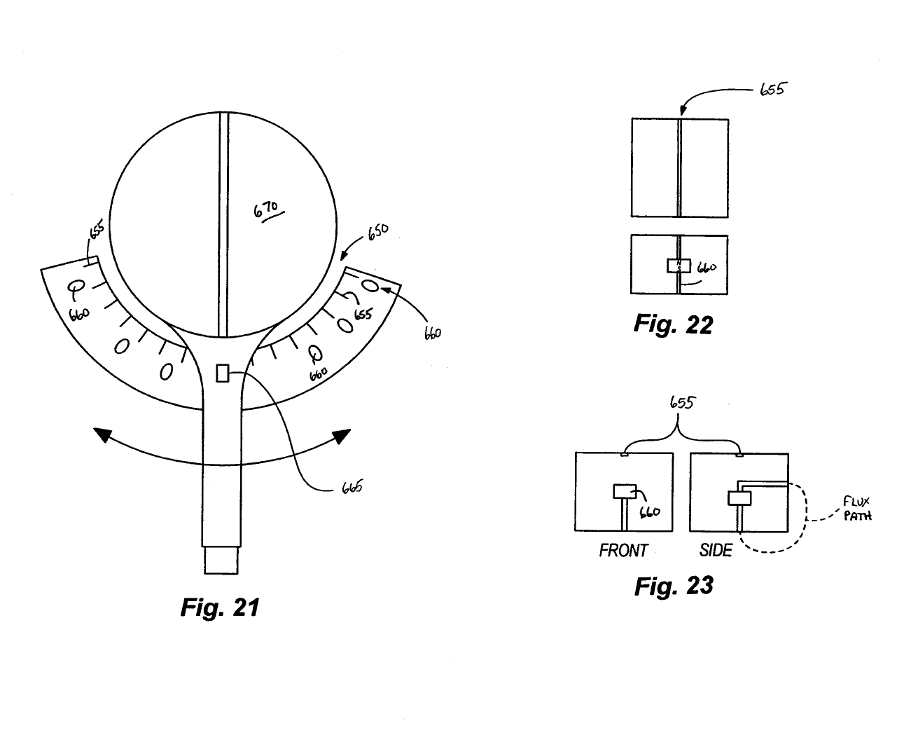

In another construction, the saw 100 may include user-adjustable detents (as described in greater detail with respect to FIG. 21 below). As such, a detent may be set wherever an operator may want it, not just an adjustment from a pre-set detent. Furthermore, an operator may find it convenient to set as many or as few detents as they wish throughout the miter angle adjustment range. Such user-adjustable detents may work in conjunction with the bevel pivot, miter pivot, or both.

For example, with reference to detents for the miter angle adjustment, a stepper motor with an encoder may be positioned on the miter axis to provide user-adjustable detents. The stepper motor may be capable of microstepping in increments at least as fine as the desired detent accuracy. An electronic circuit may be utilized to signal the stepper motor when and which coil or multiple coils to energize. Energizing the proper coil combination may provide resistance to table rotation at the proper instant such that an operator would feel as if they hit or passed through a mechanical detent. Additionally, the coils may be energized in a pattern as an operator approaches one of the detents such the operator feels the effect of a ball riding into a ramp or feels the resistance of the table increase slightly as the detent approaches. Provided sufficient strength of the stepper motor, the motor may also act as the miter lock.

Alternatively, an electromagnetic device may engage a lock, damper, or other friction or mechanical interference geometry when signaled by an electronic circuit. Such an electromagnetic device may be a single solenoid mounted in the tongue of the table 112. The solenoid may engage anywhere along the perimeter of the table 112.

Alternatively, a voice-coil mechanism mounted in the tongue of the table 112 may be utilized rather than the solenoid. The voice-coil mechanism has a fast response time, consumes less power, and is more responsive to instructions from an electronic circuit. The voice-coil device may also be energized with varying magnitude based on the position, velocity, and/or acceleration of the table. Like the stepper motor, a circuit may be programmed to simulate the feel of mechanical detents.

Independent benefits of such user-adjustable detents or electronically programmable detent devices may be the elimination of conflicting signals that a dual angle indication system may create. With a potentiometer or encoder mounted separately from a detent system, it is possible that the saw may be in a mechanical detent defined as 45 degrees (for instance), while the electronics may think and display that the saw is positioned at 45.3 degrees.

FIGS. 21-23 illustrate a miter angle scale 650 that incorporates a plurality of markings 655 in combination with a plurality of user-adjustable detents 660. In some embodiments, the user-adjustable detents 660 are magnetic, such that they can be identified by a miter angle sensor module 665 (e.g., a Hall effect sensor) for determining the position at which a table 670 is positioned relative to a base (not shown). The sensor module 660 communicates with a miter angle indicator (such as, for example, the miter digital readout arrangement 170) and a controller module (as described in greater detail with respect to FIGS. 37-42). The detent position magnets 655 may be positioned by the user (or during manufacture) at given miter angle positions. The user can then set any given table position in the controller, much like programming a pre-set radio station. A locking mechanism may be provided to hold the turntable in the desired miter angle position while programming the position of the table 665 in the controller.

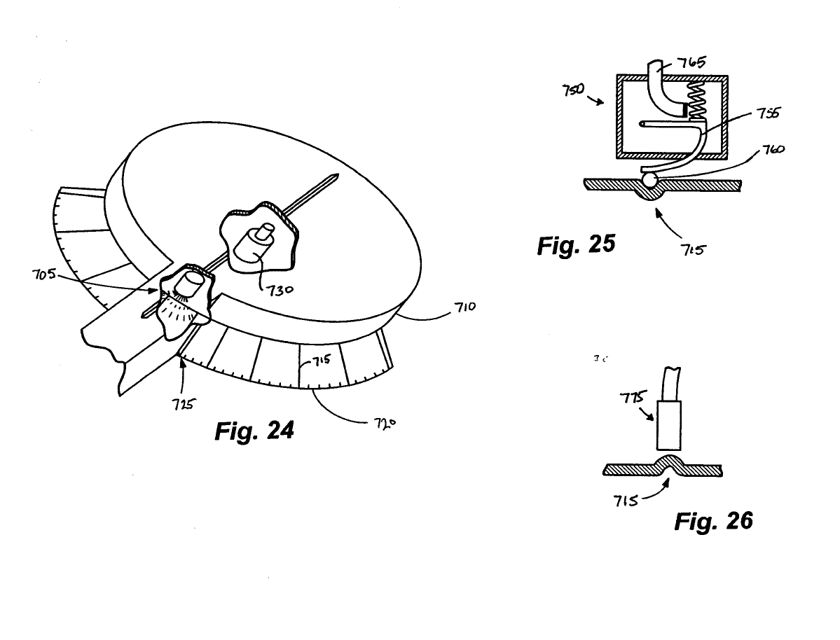

FIGS. 24-26 illustrate additional sensors that can be used to sense the position of a detent (e.g., a detent on a miter scale or a detent on a bevel scale). For example, FIG. 24 illustrates an optical sensor 705 that is included in a table 710 of a saw. The optical sensor 705 can be used to detect markings or detents 715 on a miter scale 720 of the table 710. For example, as the optical sensor 705 travels over the detents 715, a signal can be sent to a controller that indicates the position of the table 710. In some embodiments, wipers 725 are included on each side of the portion of the table 710 that travels over the miter scale 720. The wipers 725 can be used to clear the miter scale 720 of any debris that might negatively affect the operation of the optical sensor 705. In some embodiments, a potentiometer 730 is also included, which can work in conjunction with the optical sensor 705 to provide a signal to a digital display. For example, the optical sensor 705 can be used to recalibrate the potentiometer 730, as previously described. In an alternative embodiment, as shown in FIG. 25, a mechanical switch assembly 750 can be used to detect detents 715. The mechanical switch assembly 750 includes an arm 755 having a roller or ball 760, which directly contacts the detents 715. Movement of the ball 760 and/or arm can be detected by a sensing element 765 in the switch assembly 750. In another alternative embodiment, as shown in FIG. 26, a proximity switch 775 can be used to detect detents 715. For example, the proximity switch 775 detects the change in elevation of the detents 715.

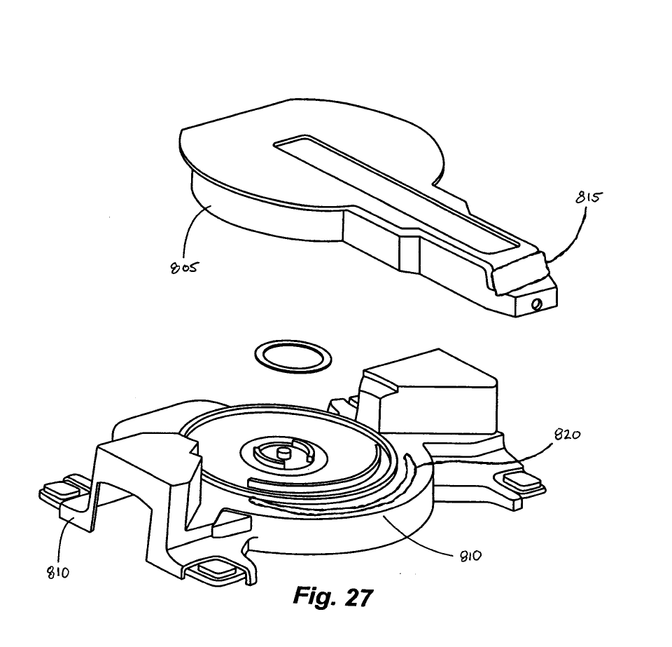

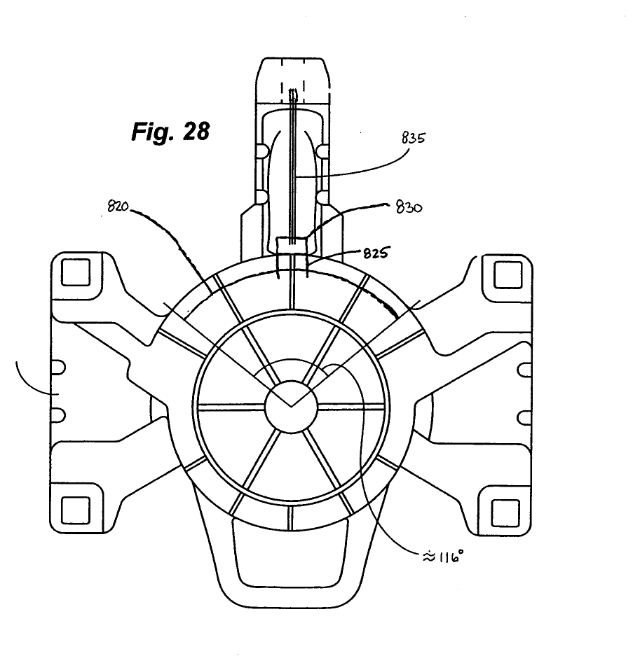

FIGS. 27-32 illustrate additional constructions for sensing and communicating to a user a miter angle of a table 805 relative to a base 810. It should be understood that the concepts described with respect to FIGS. 27-32 can be similarly implemented for sensing and communicating to a user a bevel angle of a saw blade relative to the table 805. In some constructions, the table 805 may include a capacitive angle measurement and digital readout 815, in a manner similar to digital calipers. For example, a rail 820 of the calipers would be curved around the radius of the base 810, and wipers 825 of the calipers would be mounted on the tongue of the table 805 (See FIG. 28). The wipers 825 may be provided to remove moisture from the rail 820 as a sensing element 830 moves past. The wipers 825 may remove other debris, such as sawdust. The sensing element 830 (see FIG. 28) can sense the position of the table 805 by interacting with the rail 820. In some embodiments, a wiring harness 835 is used to transmit a signal from the sensing element 830 to the digital readout 815. Rather than displaying a linear distance, the display 815 can be programmed to display an angle to which the table is adjusted. In some embodiments, the table 805 is movable throughout an approximately 116 degree range, as indicated in FIG. 28. In other embodiments, the table 805 may be movable more or less than that shown. A similar digital caliper is described and illustrated in U.S. Pat. No. 4,449,179, the entire contents of which are hereby incorporated by reference.

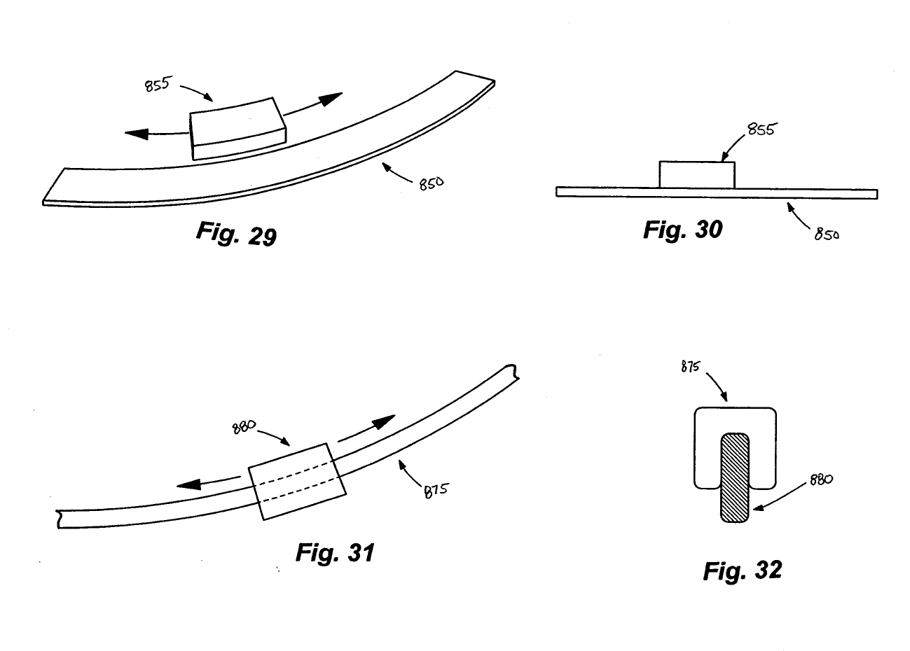

As shown in FIG. 29, in some embodiments, the rail 820 can be embodied as a dimensionally stable tape 850. The tape 850 may include a series of very accurate copper rectangles plated on it using printed circuit technology may be supported on a stationary part (e.g., the base 810). A sliding part 855 supported on a moving part (e.g., the table 805) has a similar but finer pitch pattern plated on it, and the ratio of capacity between the slider rectangles and the tape rectangles is used to calculate how far the slider 855 has moved relative to the tape 850. Such an arrangement provides in incremental encoder to determine how far the slider has been moved from the last zero set-point. Such technology is reasonably rugged because there are no sliding contacts which wear. FIG. 30 illustrates a front view of the tape 850 and slider 855. The arrangement may include a “coolant-proof” digital caliper which alleviates the effects of changes in moisture which may affect the dielectric constant. In some embodiments, the slider 855 can be substantially arc-shaped. Additionally, the tape 850 and slider 855 can be mounted internally to a saw body (e.g., internal to the table 805 and base 810 components), which can protect the tape 850 and slider 855 from mechanical damage during use, storage and transport. FIG. 31 illustrates an alternative arrangement in which a slider 875 at least partially surrounds a tape or rail 880. FIG. 32 illustrates a front, cross-sectional view of the arrangement shown in FIG. 31.

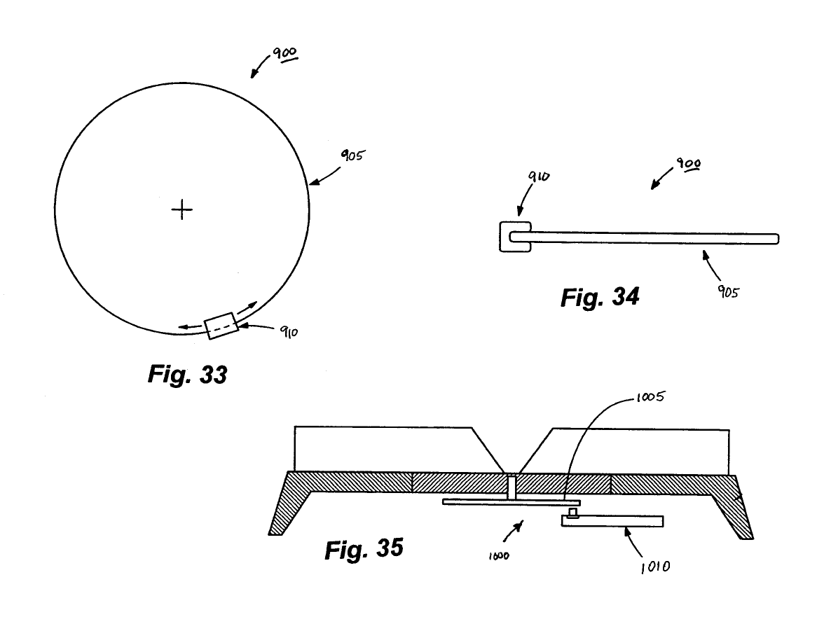

FIGS. 33 and 34 illustrate another embodiment of a position sensing device 900, similar to the rail 875 and slider 880 shown in FIGS. 31-32. FIG. 33 is a top view of the position sensing device 900, which generally includes a disk 905 and a slider element 910. In some embodiments, the disk 905 can be coupled to the base 108 of the saw 100, while the slider element 910 can be coupled to the table 112 of the saw 100. As such, when the table 112 is moved with respect to the base 108, the slider element 910 will also move along the disk 905. This movement can provide an indication of the position of the table 112. The position information can then be transmitted to, for example, the miter digital readout arrangement 170. FIG. 34 is a front or side view of the position sensing device 900 shown in FIG. 33.

FIG. 35 illustrates a position sensing device 1000 having a rotary encoder disc 1005 and an electronics module 1010. In the embodiment shown, the rotary encoder disc 1005 is positioned to be coupled to a table of a saw (such as the table 112 of the saw 100), such that the rotary encoder disc 1005 turns as the table turns. The electronics module 1010 can be used to monitor the rotation of the rotary encoder disc 1005, and transmit a signal to a digital display that indicates the position of the table.

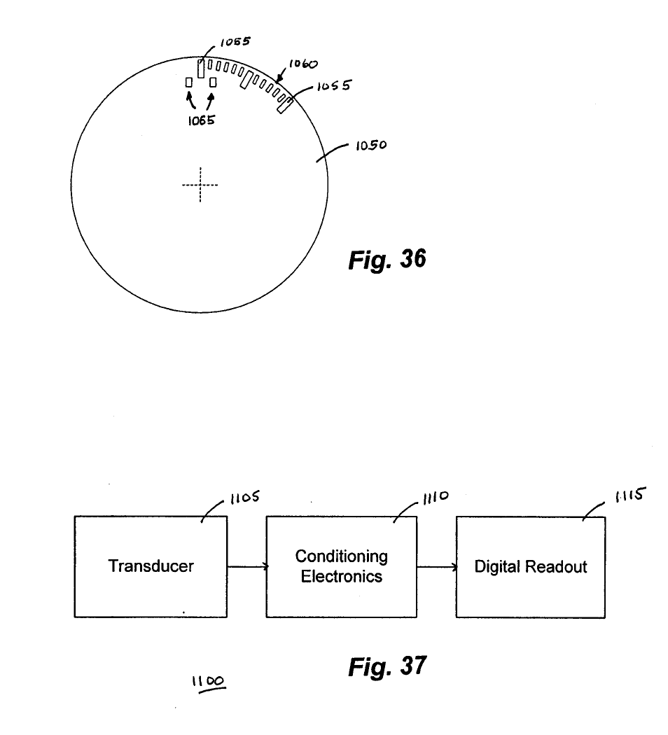

Some tools that incorporate a digital readout system to indicate a tool adjustment setting (e.g., bevel angle, miter angle, cutting tool depth, etc.) include a detent or other index position system for a user to quickly adjust the tool to a common adjustment setting, such as described above. The combination of a digital readout system and an index position system presents the challenge that the digital readout should indicate the same value as the intended index position value. If the digital readout does not indicate the intended index position value, a user may question which system is correct and which is incorrect. This challenge may be met with high-dimensional tolerances when the resolution of the digital readout is relatively more coarse than the accuracy of the index position system. However, the difficulty of meeting this challenge increases as the resolution of the digital readout system increases (e.g., for a resolution of 0.1 degrees on a miter angle). FIG. 36 illustrates an embodiment of an optical encoder disc 1050. The optical encoder disc 1050 can be used in conjunction with an optical sensing element (e.g., see FIG. 24) to measure the tool adjustment setting. As shown in FIG. 36, the optical encoder disc 1050 includes relatively larger slots or marks 1055, relatively smaller slots or marks 1060, and one or more direction markings 1065. In some embodiments, the relatively larger slots or marks 1055 are positioned at known reference points, for example, index or detent positions (such as 0.0 degrees, 22.5 degrees, and 45.0 degrees), and the relatively smaller slots or marks 1060 are positioned therebetween. For example, the relatively larger slots at the index positions allow for achievable dimensional tolerances to be used and still allow the displayed digital readout value to match the intended index position value. Between index positions, the relatively smaller slots or marks 1060 are sufficiently fine to provide a desired resolution, such as 0.1 degrees. Alternatively, a gray code digital encoder with relatively larger coded bands at the index positions can be used in place of an optical encoder. The direction markings 1065 are used to determine the direction of rotation of the disc 1050.

FIG. 37 illustrates a process 1100 by which a signal from a transducer 1105 (such as the transducers shown and described with respect to FIGS. 12-14) can be processed. For example, as described in greater detail below, the transducer 1105 can generate a signal that is indicative of a tool adjustment (e.g., bevel angle, miter angle, cutting tool depth, etc.). The signal can be passed from the transducer 1105 to conditioning electronics 1110, which condition or manipulate the signal. For example, in some embodiments, the transducer 1105 may transmit an analog signal (e.g., 0-10 volts, 1-10 mA, etc.). In such embodiments, the conditioning electronics 1110 may amplify the signal. Additionally or alternatively, the conditioning electronics 1110 may convert the analog signal to a digital signal. The conditioning electronics 1110 also convert the signal from the transducer 1105 to a signal that can be displayed on one or more digital readout components 1115 (e.g., the digital readout arrangements 166 and 170), or a signal associated with other output device(s).

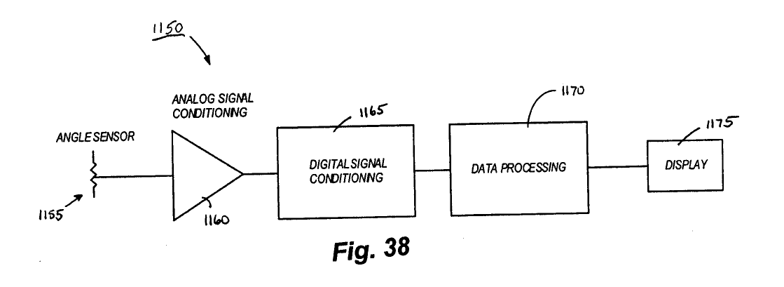

FIG. 38 illustrates another process 1150 by which a signal from a sensor 1155 is processed to produce a user-friendly digital indication of a tool adjustment. For example, a signal from the sensor 1155 (e.g., a potentiometer) is transmitted to an analog signal conditioning module 1160. The signal conditioning module 1160 amplifies the signal from the sensor 1155 to fill the range of an analog-to-digital converter. The conditioned analog signal is then transmitted to a digital signal conditioning module 1165 where it is converted from an analog signal to a digital signal. The digital signal conditioning module 1165 can also process the digital signal to reduce signal noise. Such processing is known by those skilled in the art. The conditioned digital signal can then be transmitted from the digital signal conditioning module 1165 to a data processing module 1170. In some embodiments, the data processing module 1170 utilizes the conditioned digital signal to implement an auto-calibration algorithm. The data processing module can also format the signal so that it can be shown on a display 1175. For example, in some embodiments, the sensor 1155 is coupled to a table of a saw (as previously described), and the table is located in a detent, a calibration constant for that detent is loaded into a calibration lookup table, and the known position (from the table) of that detent is displayed on the display 1175. If the table is between detents, a linear interpolation estimation of the position of the table is made based upon the known positions of the detents on either side of the current position of the table. This estimation is then displayed on the display 1175. In some embodiments, the display 1175 is updated approximately five times a second. As the table is moved from one detent to another, a constantly updated calibration table is generated. Updating the calibration table compensates, for example, for mechanical wear, electrical aging, and temperature effects on the sensor and other electronic components. Apparent sensor linearity can also be improved.

In some embodiments, a more complex signal processing process may be implemented to digitally display information to a user (e.g., the process can include additional sensors 1155 and additional processing modules). Other signal processing processes can also incorporate a variety of other features. For example, in some independent aspects and in some constructions, a saw such as a miter or table saw with digital readout provides an indication that reminds the user to recalibrate the digital readout system. This can be implemented, for example, by displaying a symbol or reminder word (e.g., “RECALIBRATE” or another reminder word) across a display screen such as an LCD of a digital readout. Alternatively or additionally, (a) the screen can switch back and forth from this symbol or reminder word to the sensed angle; (b) the screen can flash the sensed angle; (c) the screen can go blank or change color; (d) the screen can display an estimated percent accuracy indicating less than perfect (100%) accuracy; (e) there can be a light or series of lights next to the display to indicate the need to recalibrate the system (e.g., green to red; or green to yellow to red); (f) the saw motor can be disabled temporarily; (g) an audible sound can be emitted; (h) a physical member can change position so as to provide a visual (and optionally audible) indicator (e.g., a recalibration button pops up); and/or (i) a physical member can change position so as to interfere with the operator's hand or interfere with an operable element of the saw to temporarily prevent usage of a certain feature of the saw, such as the motor switch, the coarse adjustment system, the fine adjustment system, and/or the tool depth adjustment system.

In some constructions, an indication to recalibrate a digital readout system (e.g., any of the indications listed above) is triggered by, for example, (a) a length of time between calibrations; (b) a distance (either angular or linear) away from a calibrated position; (c) an accumulated distance traveled (either angular or linear) away from a calibrated position; (d) signal strength of the rotational sensor; (e) number of pulses counted since last calibration; (f) another accuracy estimating process; or (g) number of cuts since last calibration. The tool returns to normal operating mode when the digital readout system is recalibrated. In constructions using a light or series of lights to indicate a need for recalibration, the light(s) return to an “accurate” indicator color (e.g., green) when the system is recalibrated.

In some independent aspects and in some constructions, a tool can be manually recalibrated in a user-friendly manner. For instance, on a saw such as a miter or table saw with digital readout, the saw can include one or more manual resetting buttons or other input devices to recalibrate the system at known positions. This button can be positioned such that the user can easily reach the button, such as with a thumb or finger, with the user's hand still on the operable gripping surface of the saw. Alternatively or additionally, a recalibration button can be positioned (a) near the motor switch such that the user can easily reach the button with a thumb or finger with the user's hand still on the main switch handle; (b) on the miter override lever, or integrated with the miter override lever; (c) on the base of the miter saw; or (d) on the fence of the miter saw. In some constructions, recalibration occurs if the button is pressed twice, and/or if the button is pressed for at least a predetermined time period.

In some independent aspects and in some constructions, when a user actuates a recalibration input device at a known (reference) position (e.g., a detent), a sensor output signal at that position is stored, associated with a value (e.g., 45 degrees) for the known position, and/or processed using a numerical method. Accordingly, during subsequent operation, when a user moves to the known position, the correct angular value is displayed on the digital readout. In some constructions, recalibration can be performed at multiple known positions. Such an approach can improve the accuracy of the digital readout across a range of motion of the rotating member(s). Interpolation or other numerical methods can be employed to improve the accuracy of the digital readout for positions that are not known positions (such as previously described).

In some independent aspects and in some constructions, manual recalibration of the digital readout system of a tool such as a miter saw is not generally necessary. In such aspects and constructions, various approaches can be employed to accurately sense angular position of, for example, a table (or other rotating member).

In some constructions of a miter saw with digital readout, analog-based circuitry to measure angular position provides a reading that is an absolute position and that is not affected by a loss of power. This approach may be termed “analog absolute.” For example, in some constructions, a device to sense angular position is a ratio-metric spinning disk system. This system converts angular velocity and time information into angular position. Alternatively or additionally, a device is a magnetic pick-up sensor that reads the signal of a magnetic field that moves relative to the sensor when the angle (miter or bevel) of the saw is changed. Potentiometers, magnet orientation schemes with Hall effect pickups, capacitive arrays with changing dielectric, and capacitance-to-digital converters (CDCs) also can be implemented (such as previously described).

In some constructions, the accuracy of an analog absolute approach can be increased by characterization of the entire analog range of sensing circuitry. For example, on a miter saw with digital readout, the digital readout system can be set up with several (or many) reference points of known positions related to known sensor output signals. The sensor output signal may not be linear, so the multiple reference points can increase the accuracy of the system by allowing the system to display a true angle at every programmed reference point. At positions between reference points, the displayed angle may be less accurate, but may be sufficiently accurate depending on the implementation. Interpolation optionally may be employed between reference points.

In some constructions of a miter saw with digital readout, digital-based circuitry to measure angular position provides a reading that is an absolute position and that is not affected by a loss of power. This approach may be termed “digital absolute.” For example, in some constructions, a gray code (e.g., a 10-12 bit gray code) or binary code is printed around the circumference of a rotating member, such as the miter saw table or the bevel hub (such as described with respect to FIGS. 27-36). A sensor affixed to the stationary member reads these codes to determine the position of the table or bevel arm in any location. Alternatively, the locations of the sensor and the indicating codes can be reversed (i.e., the code is printed on the stationary member, and the sensor is affixed to the rotating member).

In some constructions of a miter saw with digital readout, digital-based circuitry to measure angular position provides a reading that is relative to a reference position and may be affected by a loss of power. This approach may be termed “digital relative.” For example, the number of pulses from a single or multiple known reference positions (e.g., zero position) is counted in order to determine the present location of a rotating member (e.g., the table of the saw). Quadrature or other methods can be employed to determine the direction of rotation or translation and whether the angle is increasing or decreasing from the known reference point. Optics, optical printing, magnetic fields, and/or physical interruption of a surface are exemplary approaches usable to implement such constructions.

As an example of a digital relative approach, in one construction of a saw, a series of wires are wound around a cylinder, shaped into an arc, and affixed to or otherwise associated with a rotating member of the saw. A magnetic field is generated by current flowing through the series of wires. A processor determines angular position by counting the magnetic pulses of magnetic pick-up. The processor can resolve position by interpolating position between peaks in the magnetic signal. The current flowing in these wires can be AC or DC and, by passing current in alternate directions in each winding, the magnetic field in each winding adds or subtracts to help determine position. Alternatively, the magnetic fields can be provided by other means such as permanent magnets or printed magnetic ink.

In some constructions, a DISK transmissive rotary encoder disk (e.g., the DISK-1024-375-1-I or the DISK-1024-375-2) and an AEDR reflective optical encoder module offered by US Digital Corporation (Vancouver, Wash.) are used to implement a digital relative approach.

In some independent aspects and constructions of a miter saw with digital readout, a digital sensor can be used in connection with the digital relative approach described above. The digital readout system can be made more economically by using fewer pulses and a lower resolution detector. However, using fewer pulses may reduce the resolution of the digital readout. To address the reduced resolution, a low-cost analog sensor can be added to more accurately display the increments between the digital points. The low-cost analog sensor can be, for example, a resistive sensor (e.g., potentiometer) or a magnetic field sensor. The overall cost of the system using two low-cost sensors (one digital and one analog) can be lower than the overall cost of a purely digital or purely analog system.

In one exemplary construction, a digital sensor provides the whole number digits of a digital display, and an analog sensor provides the first place decimal digit of the digital display. A reset button is provided to “zero” or recalibrate the display when the tool is in the zero position (or another reference position). As the miter saw table rotates relative to the base, the analog sensor senses movement and triggers a counter that is displayed on the digital readout display from 0.0 to 0.9. The analog system does not need to store or interpolate data. As the table rotates further past 0.9, the digital sensor passes a next digital point. When the digital sensor senses the next digital point, the analog counter resets to zero. As the table continues to rotate relative to the base, the analog sensor again starts counting. An additional benefit may be realized by using the analog sensor to sense direction of rotation instead of the quadrature of the digital sensor.

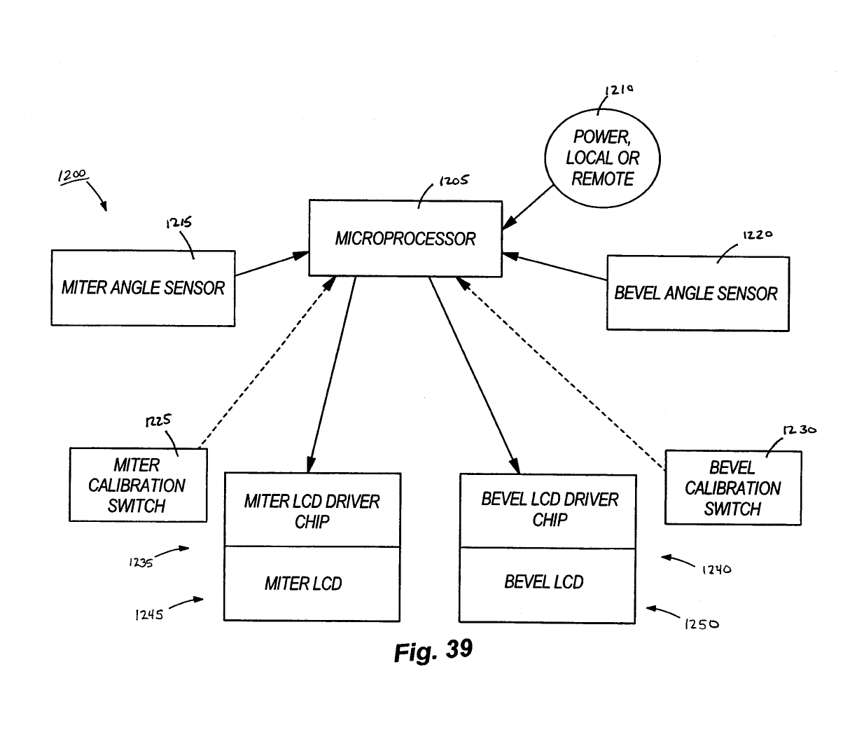

FIGS. 39-42 illustrate a variety of embodiments of interconnections between one or more microprocessors and other electronic components of a saw. These embodiments illustrate high-level representations of saw circuitry that carries out functions and operations such as those described above. However, as should be appreciated by those skilled in the art, specific implementations (not shown) may include more electronic components and more interconnections than those shown (e.g., additional drivers, power supplies, sensors, etc.). For example, FIG. 39 illustrates an embodiment 1200 including a microprocessor 1205 that receives signals from a power source 1210, a miter angle sensor 1215, a bevel angle sensor 1220, a miter calibration switch 1225, and a bevel calibration switch 1230. The microprocessor 1205 also transmits signals to a miter LCD driver 1235 and a bevel LCD driver 1240, which communicate the signals to a miter LCD 1245 and a bevel LCD 1250, respectively.

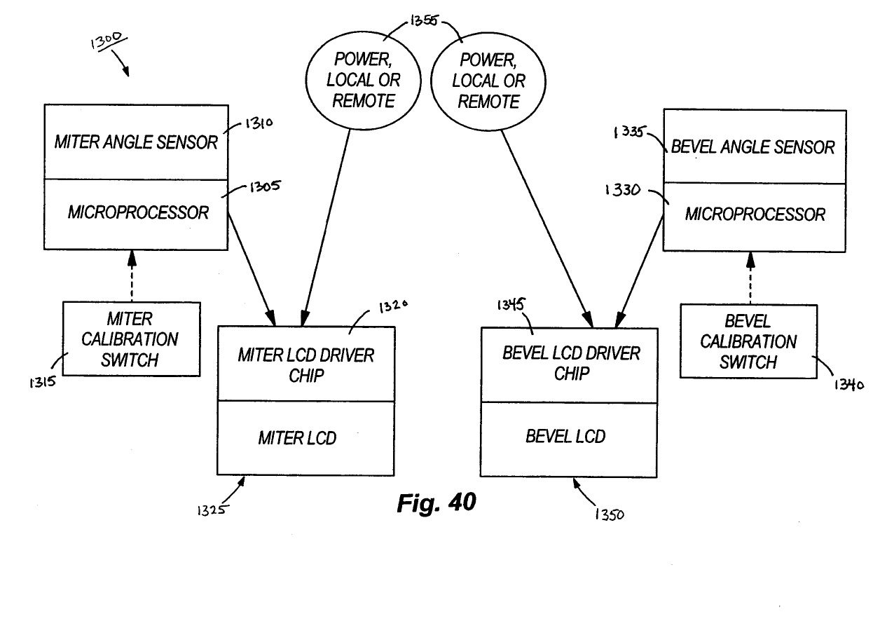

FIG. 40 illustrates another embodiment 1300 that includes two microprocessors. In the embodiment 1300 shown in FIG. 40, a miter microprocessor 1305 is incorporated or integrated with a miter angle sensor 1310. The miter microprocessor 1305 and miter angle sensor 1310 combination can receive signals from a miter calibration switch 1315, and transmit signals to a miter LCD driver 1320 and miter LCD 1325. Similarly, the embodiment 1300 also includes a bevel microprocessor 1330 that is incorporated or integrated with a bevel angle sensor 1335. The bevel microprocessor 1330 and bevel angle sensor 1335 combination can receive signals from a bevel calibration switch 1340, and transmit signals to a bevel LCD driver 1345 and bevel LCD 1350. A power supply 1355 supplies power to the miter LCD driver 1320 and the bevel LCD driver 1345.

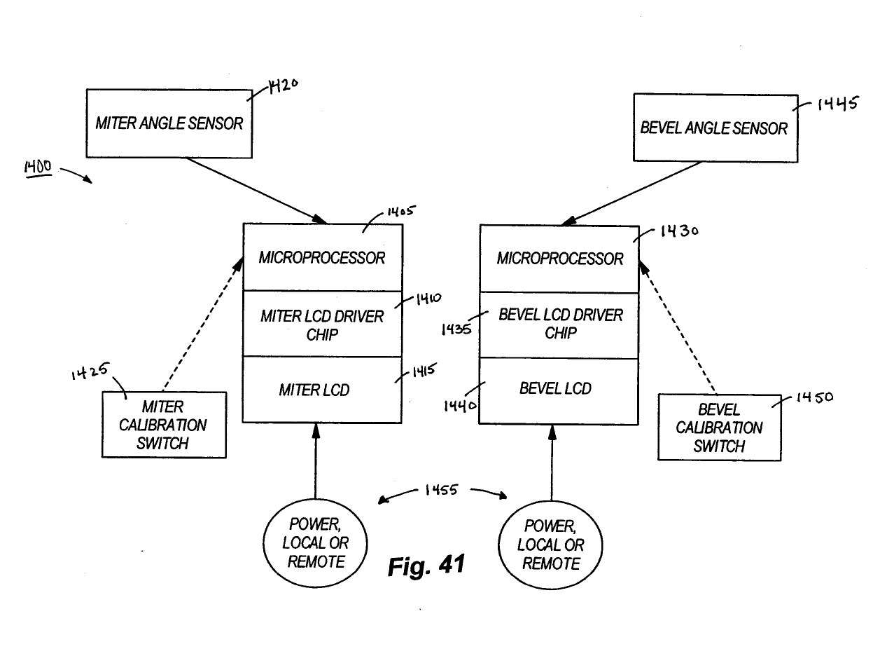

FIG. 41 illustrates another embodiment 1400 that also includes a pair of microprocessors. However, in the embodiment shown in FIG. 41, a miter microprocessor 1405 is incorporated or integrated with a miter LCD 1410 driver and miter LCD 1415. The miter microprocessor 1405, similar to the embodiment shown in FIG. 40, receives signals from a miter angle sensor 1420 and a miter calibration switch 1425. A similar microprocessor combination is provided for bevel adjustment, including a bevel microprocessor 1430 that is incorporated or integrated with a bevel LCD 1435 and a bevel LCD 1440. The bevel microprocessor 1430 receives signals from a bevel angle sensor 1445 and a bevel calibration switch 1450. A power supply 1455 provides power to both the miter microprocessor combination (1405-1415) and the bevel microprocessor combination (1430-1440).

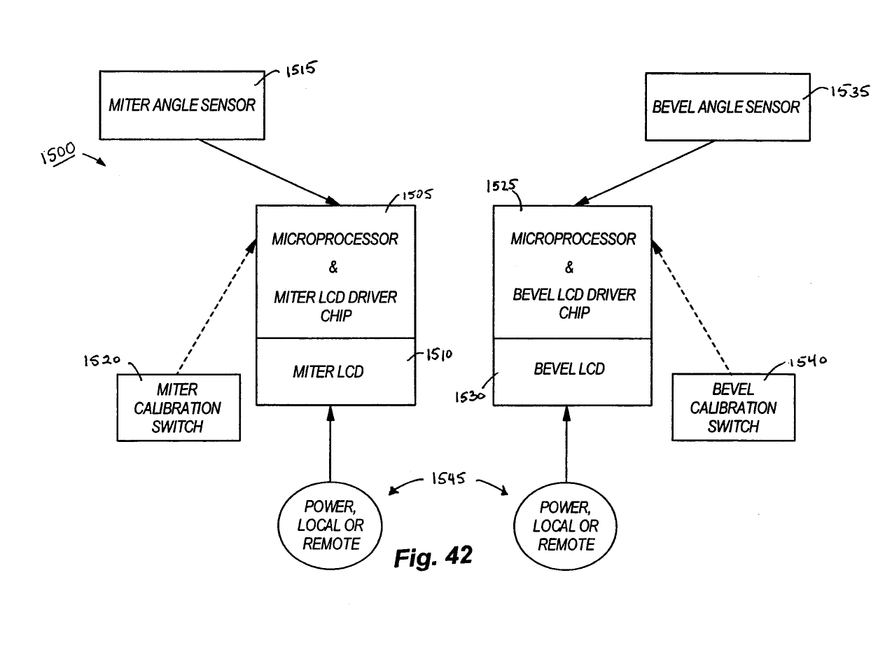

FIG. 42 illustrates an embodiment 1500 that includes a miter microprocessor with onboard LCD driver 1505 that is integrated with a miter LCD 1510. Similar to the embodiments shown in FIGS. 40-41, the miter microprocessor 1505 receives signals from a miter angle sensor 1515 and a miter calibration switch 1520. The embodiment also includes a bevel microprocessor with onboard LCD driver 1525 that is integrated with a bevel LCD 1530. The bevel microprocessor 1525 receives signals from a bevel angle sensor 1535 and a bevel calibration switch 1540. The miter LCD 1510 and bevel LCD 1530 both receive power from a power supply 1545. The embodiments described with respect to FIGS. 39-42 each include a miter calibration switch and a bevel calibration switch. However, as described above, in some embodiments, calibration switches are not required.

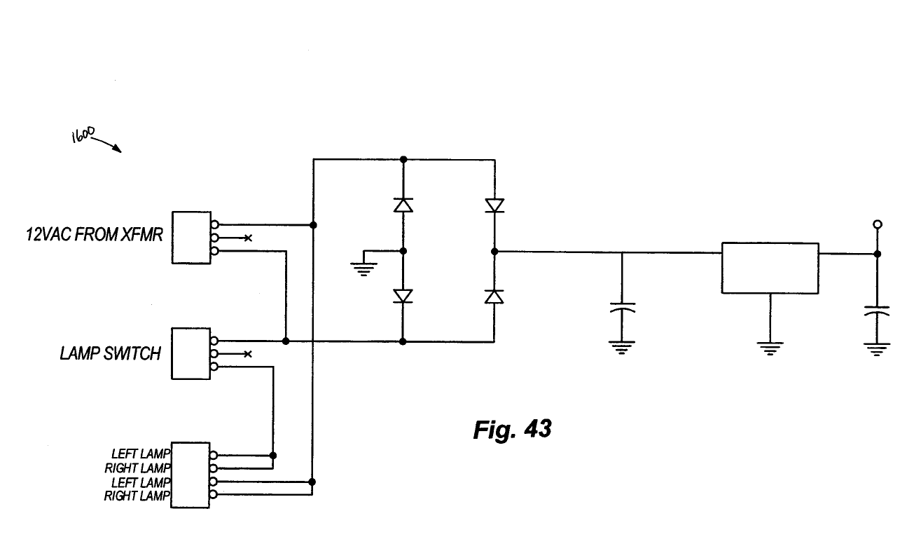

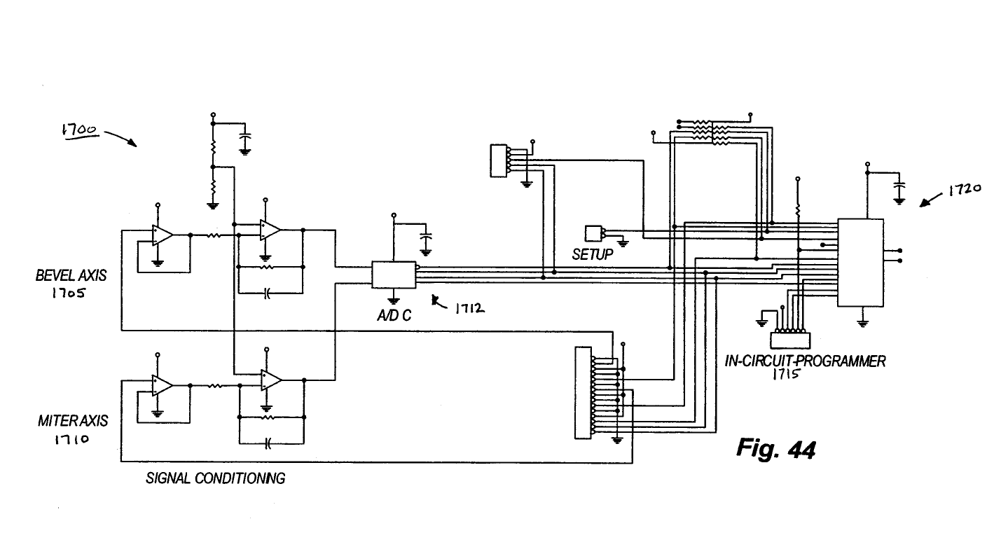

FIG. 43-44 are schematic diagrams of circuits that can be implemented in a saw. For example, FIG. 43 illustrates an embodiment of a circuit 1600. In some embodiments, the circuit 1600 can be implemented in the illumination assembly 186 (see FIG. 11). FIG. 44 illustrates an embodiment of a circuit 1700. The circuit 1700 can be implemented in, for example, an electronics module that provides a representation of a tool adjustment (e.g., bevel angle, miter angle, cutting tool depth, etc.) to a user on a digital display, such as described above. As shown in FIG. 44, the circuit 1700 includes signal conditioning circuitry for a bevel axis 1705 and a miter axis 1710. Additionally, the circuit 1700 includes an analog-to-digital (“A/D”) converter 1712, an in-circuit programmer 1715, and a microprocessor 1720. In some embodiments, the in-circuit programmer 1715 may be used to input positions of user-adjustable detents (as described above), while the microprocessor 1720 can be used to evaluate an auto-calibration algorithm (as described above).

FIGS. 45-47 illustrate a wiring arrangement 1800 for at least a portion of a saw, such as the saw 100. For example, as shown in FIG. 45, generally, the wiring arrangement 1800 includes a microprocessor 1805 that is in communication with a bevel sensor 1810, a miter sensor 1815, a bevel readout 1820, and a miter readout 1825.

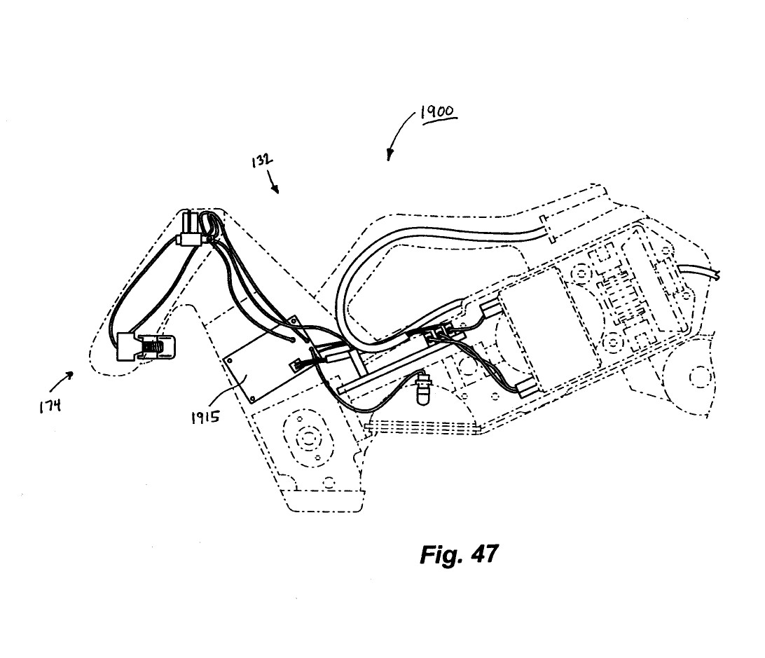

More specifically, FIG. 46-47 illustrates a wiring arrangement 1900 that is applied to the saw 100 (see FIG. 1). As shown in FIG. 46, a miter angle sensor 1905 and a bevel angle sensor 1910, such as potentiometers, are provided for determining the miter angle position and the bevel angle position of the saw blade 128. These sensors 1905 and 1910 communicate with a controller 1915 which, in turn, communicates with a corresponding display, including a miter display 1920 and a bevel display 1925.

A wiring arrangement, such as a coiled wire 1930, may be provided to accommodate movement between the controller 1915 and the displays 1920 and 1925 and/or the sensors 1905 and 1910. In the illustrated construction, the controller 1915 is supported on the saw unit 132 which is slidable relative to the base 108 (on which the miter angle sensor 1905 is supported) and the table 112 (on which the miter display 1920 is supported). The coiled wire 1930 extends through a slide tube 1935 to connect the controller 1915 to the miter angle sensor 1905 and miter display 1920 for the miter angle position.

It should be understood that the various independent aspects of the present invention discussed above may be utilized independently of one another or in combination with one or more other independent aspects of the invention. Various features and embodiments of the invention are set forth in the following claims.

What is claimed is:

1. A saw comprising:
a base;
a table configured to be movable with respect to the base, wherein the base is stationary and the table is rotatable between a first position and at least one angular position removed from the first position;
a motor coupled to the base and configured to rotate a blade, wherein the blade is movable between a first, substantially vertical position and at least one angular position removed from the first position;
a first sensor having an optical encoder disc, wherein the first sensor is configured to generate and transmit a first signal indicative of the angular position of the table with respect to the base or the angular position of the blade with respect to the first, substantially vertical position by monitoring one or more optical reference elements included on the optical encoder disc;
a controller configured to receive the first signal from the first sensor, to process the first signal from the first sensor, and to generate and transmit a conditioned signal based at least partially on the received signal; and
a display element configured to receive the conditioned signal from the controller and to display the angular position of the table with respect to the base or the angular position of the blade with respect to the first, substantially vertical position.

2. The saw of claim 1, wherein the optical encoder disc includes first optical reference elements of a first size and second optical reference elements of a second size, the second size being relatively smaller than the first size.

3. The saw of claim 2, wherein the base includes a miter scale having one or more detents positioned on the miter scale corresponding to one or more approximate angular positions of the table with respect to the base and the first optical reference elements are positioned on the optical encoder disc at the detent positions.

4. The saw of claim 3, wherein the second optical reference elements are positioned between the first optical reference elements.

5. The saw of claim 1, wherein the base includes a scale having one or more detents positioned on the scale corresponding to one or more approximate angular positions of the table with respect to the base, the saw further comprising a second sensor configured to transmit a second signal indicative of rotation of the table past the one or more detents.

6. The saw of claim 5, wherein the controller is configured to receive the second signal and compare the second signal to the first signal.

7. The saw of claim 6, wherein the controller is configured to generate a signal indicating a need for the first sensor to be recalibrated, the display element receives the signal from the controller indicating the need for the first sensor to be recalibrated, and the display element indicates the need for the first sensor to be recalibrated.

8. The saw of claim 7, further comprising a signal generator configured to generate an audible signal to indicate the need for the first sensor to be recalibrated.

9. The saw of claim 6, wherein the controller is configured to automatically recalibrate the first sensor based at least partially on the comparison of the second signal to the first signal.

10. A saw comprising:
a base;
a table configured to be movable with respect to the base, wherein the base is stationary and the table is rotatable between a first position and at least one angular position removed from the first position;
a motor coupled to the base and configured to rotate a blade, wherein the blade is movable between a first, substantially vertical position and at least one angular position removed from the first position;
a first sensor configured to transmit a first signal indicative of the angular position of the table with respect to the base or the angular position of the blade with respect to the first, substantially vertical position, wherein the first sensor is operable to be recalibrated;
a controller configured to receive the first signal from the sensor, to process the signal from the first sensor, to determine a need to recalibrate the first sensor, and to generate a conditioned signal based at least partially on the determination; and
an output element configured to receive the conditioned signal from the controller and to provide an indication to a user of the need to recalibrate the first sensor.

11. The saw of claim 10, wherein the controller is configured to determine the need to recalibrate the first sensor based at least partially on one of an elapsed time period, an amount by which the table has been rotated or the blade has been moved, and a combination thereof.

12. The saw of claim 10, wherein the indication is visual, audible, or a combination thereof.

13. The saw of claim 10, wherein the output element is further configured to indicate the angular position of the table with respect to the base or the angular position of the blade with respect to the first, substantially vertical position.

14. The saw of claim 13, wherein the output element is configured to alternate between an indication of an angular position and an indication of the need to recalibrate the first sensor.

15. The saw of claim 10, wherein a scale is included on the base, the motor, or both, and further comprising a second sensor configured to transmit a second signal indicative of the position of the table or the blade with respect to the scale.

16. The saw of claim 15, wherein the controller is configured to determine the need to recalibrate the first sensor based at least partially on a comparison of the first signal transmitted from the first sensor and the second signal transmitted from the second sensor.

17. The saw of claim 15, wherein the controller is configured to automatically recalibrate the first sensor based at least partially on the signal from the second sensor.

18. A saw comprising:
a base;
a table configured to be movable with respect to the base, wherein the base is stationary and the table is rotatable between a first position and at least one angular position removed from the first position;
a motor coupled to the base and configured to rotate a blade, wherein the blade is movable between a first, substantially vertical position and at least one angular position removed from the first position;
a digital sensor configured to generate and transmit a first signal indicative of the angular position of the table with respect to the base or the angular position of the blade with respect to the first, substantially vertical position, wherein the first signal is generated by determining an angular distance by which the table or the blade is moved from one or more known reference points;
an analog second sensor configured to generate and transmit a second signal indicative of the angular position of the table with respect to the base or the angular position of the blade with respect to the first, substantially vertical position, wherein the second signal varies according to the angular position of the table or the blade;
a controller configured to receive and process the first signal and the second signal, and to generate and transmit a conditioned signal based at least partially on the first signal and the second signal; and
a display element configured to receive the conditioned signal from the controller and to display the angular position of the table with respect to the base or the angular position of the blade with respect to the first, substantially vertical position.

19. The saw of claim 18, wherein the digital sensor includes one or more digital sensor elements, and the digital sensor is configured to generate the first signal by counting pulses between the one or more known reference points, wherein the pulses are generated from an magnetic interaction between the one or more digital sensor elements.

20. The saw of claim 19, wherein the conditioned signal includes a whole degree component and a fractional degree component, the whole degree component being derived from the first signal, the fractional degree component being derived from the second signal.
